(19) United States
(12) Patent Application Publication
(10) Pub. No.: US 2021/0197530 A1
(43) Pub. Date: Jul. 1, 2021

(54) SOLAR CONTROL COMPOSITE FILM

(71) Applicant: SAINT-GOBAIN PERFORMANCE PLASTICS CORPORATION, Solon, OH (US)

(72) Inventors: Antoine DIGUET, Paris (FR); Daniele COSTANTINI, Paris (FR); Jean-Baptiste LAUDEREAU, Paris (FR)

(21) Appl. No.: 17/120,604

(22) Filed: Dec. 14, 2020

Related U.S. Application Data
(60) Provisional application No. 62/955,084, filed on Dec. 30, 2019.

(51) Int. Cl. B32B 15/095; B32B 3/12; B32B 27/06; B32B 27/40

(52) U.S. Cl. CPC B32B 15/095; B32B 3/12; B32B 27/06; B32B 27/40; B32B 2037/268; B32B 2250/44; B32B 2255/06; B32B 2255/26; B32B 2311/08; B32B 2250/02

(57) ABSTRACT

A composite film may include a discontinuous silver-based functional film, and a TPU over-layer overlying the discontinuous silver-based functional film. The composite film may have an R/sq value of at least about 30 Ohm/sq.

### CROSS-REFERENCE TO RELATED APPLICATION(S)

This application claims priority under 35 U.S.C. § 119(e) to U.S. Provisional Application No. 62/955,084, entitled “SOLAR CONTROL COMPOSITE FILM,” by Antoine DIGUET et al., filed Dec. 30, 2019, which is assigned to the current assignee hereof and is incorporated herein by reference in its entirety.

### FIELD OF THE DISCLOSURE

The present disclosure relates to a solar control film. In particular, the present disclosure relates to a solar control film having particular solar energy characteristics and high radio-frequency (i.e., RF) transparency that may be configured for use on an automobile window or an automobile sunroof.

### BACKGROUND

Composite films can be used as coverings applied to windows in building or vehicles to control the passage of solar radiation through transmission, reflection, and absorption. For certain composite films, visible light transmission and reflection must be low and the total solar energy rejection must be high. However, such composite films also attenuate radio-frequencies from passing through the film. In certain circumstances, a need exists for composite films which have superior visible light transmittance, visible light reflection, and total solar energy rejection properties at the desired levels in combination with high RF transparency.

### SUMMARY

According to a first aspect, a composite film may include a discontinuous silver-based functional film, and an over-layer overlying the discontinuous silver-based functional film. The over-layer may include thermoplastic polyurethane (hereinafter “TPU”). The composite film may have an R/sq value of at least about 30 Ohm/sq.

According to a yet another aspect, a laminate may include a first substrate, a discontinuous silver-based functional film overlying the first substrate, an over-layer overlying the discontinuous silver-based functional film, and a second substrate overlying the over-layer. The over-layer may include TPU. The laminate may have an R/sq value of at least about 30 Ohm/sq.

According to still another aspect, a method of forming a composite film may include providing a silver-based functional film attached to a first surface of a sacrificial film, conducting a first lamination of an over-layer onto a second surface of the silver-based functional film, where the silver-based functional film is between the over-layer and the sacrificial film, conducting a delamination of the silver-based functional film from the sacrificial film to form a discontinuous silver-based functional film attached to the TPU over-layer. The over-layer may include TPU.

According to a first aspect, a composite film may include an under-layer, a discontinuous silver-based functional film overlying the under-layer, and an over-layer overlying the discontinuous silver-based functional film. The under-layer may include TPU and the over-layer may include TPU. The composite film may have an R/sq value of at least about 30 Ohm/sq.

According to a yet another aspect, a laminate may include a first substrate, an under-layer overlying the first substrate, a discontinuous silver-based functional film overlying the under-layer, an over-layer overlying the discontinuous silver-based functional film, and a second substrate overlying the over-layer. The under-layer may include TPU and the over-layer may include TPU. The laminate may have an R/sq value of at least about 30 Ohm/sq.

According to still another aspect, a method of forming a composite film may include providing a silver-based functional film attached to a first surface of a sacrificial film, conducting a first lamination of an over-layer onto a second surface of the silver-based functional film, where the silver-based functional film is between the over-layer and the sacrificial film, conducting a delamination of the silver-based functional film from the sacrificial film to form a discontinuous silver-based functional film attached to the over-layer, and conducting a second lamination of the discontinuous silver-based functional film attached to the over-layer onto an under-layer to form a composite film, where the discontinuous silver-based functional film is between the over-layer and the under-layer. The under-layer may include TPU and the over-layer may include TPU.

### BRIEF DESCRIPTION OF THE DRAWINGS

Embodiments are illustrated by way of example and are not limited in the accompanying figures.

FIG. 1 includes a diagram illustrating of a composite film forming method according to certain embodiments described herein;

FIG. 2 includes an illustration of an example composite film according to certain embodiments described herein;

FIG. 3 includes an illustration of a discontinuous silver-based functional film according to certain embodiments described herein;

FIG. 4 includes an illustration of an example laminate including a composite film according to certain embodiments described herein;

FIG. 5 includes a diagram illustrating of a composite film forming method according to certain embodiments described herein;

FIG. 6 includes an illustration of an example composite film according to certain embodiments described herein;

FIG. 7 includes an illustration of a discontinuous silver-based functional film according to certain embodiments described herein; and

FIG. 8 includes an illustration of an example laminate including a composite film according to certain embodiments described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention. Further, the use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

As used herein, the term “visible light transmission” or “VLT” refers to the ratio of total light visible to the human eye (i.e., having a wavelength between 380 nm and 780 nanometers) that is transmitted through a composite stack/transparent substrate system and may be calculated using a D65 light source at a 10° angle based on standard ISO9050.

The term “visible light reflection” or “VLR” refers to the ratio of total light visible to the human eye (i.e., having a wavelength between 380 nm and 780 nanometers) that is reflected by a composite stack/transparent substrate system and may be calculated using a D65 light source at a 10° angle based on standard ISO9050.

The term “visible light absorption” or “VLA” refers to the ratio of total light visible to the human eye (i.e., having a wavelength between 380 nm and 780 nanometers) that is absorbed by a composite stack/transparent substrate system and may be calculated using a D65 light source at a 10° angle based on standard ISO9050.

The term “solar energy transmission” or “TE” refers to the ratio of solar energy (having wavelength between 300 nm and 2500 nm) that is transmitted through the composite stack and is calculated based on standard ISO9050.

The term “solar energy reflection” or “RE” refers to the ratio of solar energy (having wavelength between 300 nm and 2500 nm) that is reflected by the composite stack and is calculated based on standard ISO9050.

The term “total solar energy transmitted” or “TTS” through the composite stack refers to the contribution of fraction of energy in addition to TE, which is absorbed and then reemitted, and which is calculated based on standard ISO13837.

The term haze lever or “Haze” is the ratio of the electromagnetic ray transmitted through a material, having a dispersion level higher than 2.5° regarding incidence direction of the ray and is calculated based on ISO 14782 and ASTMD1003.

The term “sheet resistance” or “R/Sq” is the resistance of a film in which current is propagating along the plane of the film. The R/Sq value of the resistance is equal to sheet resistance when the film has a square shape and is independent on size of square edge. It is commonly measured with a 4-points probe measurement system, or with a non-contact measurement system relying on induction phenomenon.

It will be appreciated that for purposes of embodiments described herein, an optical property referred to as a “functional film” optical property (i.e., a functional film VLT, a functional film VLA, etc.) refers to the optical property measurement made with the functional film.

It will be appreciated that for purposes of embodiments described herein, an optical property referred to as a “laminate” optical property (i.e., a laminate VLT, a laminate VLA, etc.) refers to the optical property measurement made with the laminate.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the solar control arts.

Embodiments described herein are generally directed to composite films and methods of forming composite films that include a discontinuous silver-based functional film, and an over-layer overlying the discontinuous silver-based functional film, where the over-layer include TPU. According to particular embodiments described herein, such composite films may have particular performance characteristics, such as, high visible light transmittance, low TTS and high RF transparency (i.e., a high R/sq value).

These concepts are better understood in view of the embodiments described below that illustrate and do not limit the scope of the present disclosure.

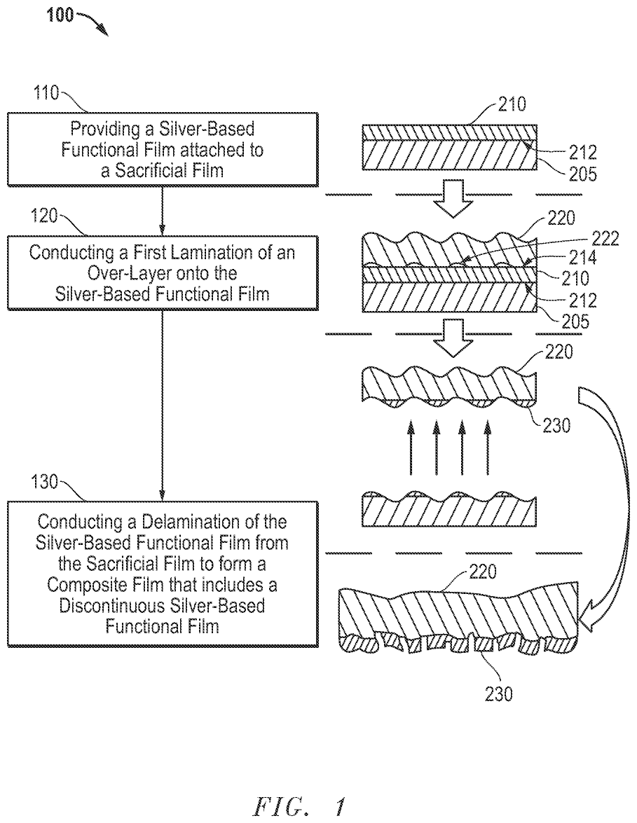

Referring first to methods of forming composite films according to embodiments described herein, FIG. 1 includes a diagram demonstrating a composite film formation method 100 for forming a composite film 200. According to particular embodiments, and as shown in FIG. 1, the composite film formation method 100 may include a first step 110 of providing a silver-based functional film 210 with a first surface 212 attached to a sacrificial film 205, a second step 120 of conducting a first lamination of an over-layer 220 onto a second surface 214 of the silver-based functional film 210, where the over-layer 220 includes TPU and where the silver-based functional film 210 is between the over-layer 220 and the sacrificial film 205, a third step 130 of conducting a delamination of the silver-based functional film 210 from the sacrificial film 205 to form the composite film 200, where the discontinuous silver-based functional film 230 attached to the over-layer 220.

Regarding the first step 110 of providing a silver-based functional film 210 with a first surface 212 attached to a sacrificial film 205, according to certain embodiments, the silver-based functional film 210 that is attached to the sacrificial film 205 may be a single silver-based functional layer. According to still other embodiments, the silver-based functional film 210 that is attached to the sacrificial film 205 may be a multi-layer composite film that includes at least one silver-based functional layer. It will be appreciated that the silver-based functional film 210 that is attached to the sacrificial film 205 may be a multi-layer composite film that further includes a sequence of additional layers made from various materials that are intended for various purposes, such as, for example, dielectric layers, blocker layer, growth layer or any combination thereof.

According to still other embodiments, the sacrificial film 205 may include a polyethylene terephthalate (PET) material. According to another particular embodiment, the sacrificial film 205 may consist of a PET material. According to still other embodiments, the sacrificial film 205 may be a PET film.

Now regarding second step 120 of conducting a first lamination of an over-layer 220 onto a second surface 214 of the silver-based functional film 210, where the over-layer 220 includes TPU and where the silver-based functional film 210 is between the over-layer 220 and the sacrificial film 205, according to certain embodiments, the over-layer 220 used in the first lamination step may have a particular thickness. For example, the over-layer 220 used in the first lamination step may have an average thickness of at least about 0.015 mm, such as, at least about 0.02 mm or at least about 0.025 mm or at least about 0.03 mm or at least about 0.035 mm or at least about 0.04 mm or at least about 0.045 mm or at least about 0.05 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to still other embodiments, the over-layer 220 used in the first lamination step may have an average thickness of not greater than about 3 mm, such as, not greater than about 2.5 mm or not greater than about 2.0 mm or not greater than about 1.5 mm or not greater than about 1.0 mm or not greater than about 0.9 mm or even not greater than about 0.8 mm. It will be appreciated that the over-layer 220 used in the first lamination step may have an average thickness within a range between any of minimum and maximum values noted above. It will be further appreciated that the over-layer 220 used in the first lamination step may have an average thickness of any value between any of the minimum and maximum values noted above.

According to other embodiments, a first surface 222 of the over-layer 220 used in the first lamination step may have a particular average surface roughness. For example, the first surface 222 of the over-layer 220 used in the first lamination step may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the first surface 222 of the over-layer 220 used in the first lamination step may have an average surface roughness of not greater than about 200 microns, such as, not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns not greater than about 90 microns or not greater than about 80 microns or not greater than about 70 microns or even not greater than about 60 microns. It will be appreciated that the first surface 222 of the over-layer 220 used in the first lamination step may have an average surface roughness within a range between any of minimum and maximum values noted above. It will be further appreciated that the first surface 222 of the over-layer 220 used in the first lamination step may have an average surface roughness of any value between any of the minimum and maximum values noted above.

According to still other embodiments, the over-layer 220 used in the first lamination step may have a second surface that does not contact the discontinuous silver-based functional film 230. According to certain embodiments, the second surface of the over-layer 220 used in the first lamination step may have a particular average surface roughness. For example, the second surface of the over-layer 220 used in the first lamination step may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the second surface of the over-layer 220 used in the first lamination step may have an average surface roughness of not greater than about 200 microns, such as, not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or even not greater than about 60 microns. It will be appreciated that the second surface of the over-layer 220 used in the first lamination step may have an average surface roughness within a range between any of minimum and maximum values noted above. It will be further appreciated that the second surface 224 of the over-layer 220 used in the first lamination step may have an average surface roughness of any value between any of the minimum and maximum values noted above.

Regarding third step 130 of conducting a delamination of the silver-based functional film 210 from the sacrificial film 205 to form a composite film 200, which includes a discontinuous silver-based functional film 230 attached to the over-layer 220, according to certain embodiments, the discontinuous silver-based functional film 230 formed through the delamination step may be a single silver-based functional layer. According to still other embodiments, the discontinuous silver-based functional film 230 formed through the delamination step may be a multi-layer composite film that includes at least one silver-based functional layer. It will be appreciated that the discontinuous silver-based functional film 230 formed through the delamination step may be a multi-layer composite film that further includes a sequence of additional layers made from various materials that are intended for various purposes, such as, for example, dielectric layers, blocker layer, growth layer or any combination thereof.

According to still other embodiments, the discontinuous silver-based functional film 230 attached to the over-layer 220 may receive additional treatments after formation. For example, the discontinuous silver-based functional film 230 attached to the over-layer 220 may be stretched to enhance the function of the discontinuities of the discontinuous silver-based functional film 230 (i.e., widen the discontinuities).

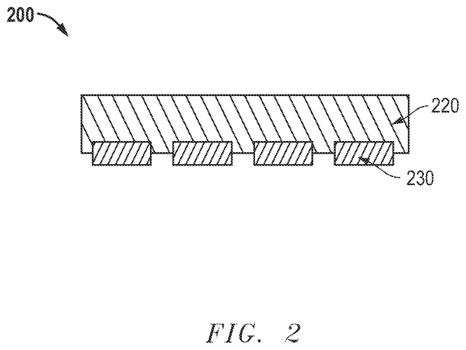

Referring now to the composite film 200 formed according to embodiments described herein, the composite film 200 may have a particular structure. FIG. 2 includes an illustration of a cross-sectional view of a portion of an embodiment of a composite film 200. As shown in FIG. 2, the composite film 200 may include a discontinuous silver-based functional film 230, and an over-layer 220 overlying the discontinuous silver-based functional film 220. According to particular embodiments, the over-layer 220 may include TPU.

According to particular embodiments, the discontinuous silver-based functional film 230 may be a single silver-based functional layer. According to still other embodiments, the discontinuous silver-based functional film 230 may be a multi-layer composite film that includes at least one silver-based functional layer. It will be appreciated that the discontinuous silver-based functional film 230 may be a multi-layer composite film that further includes a sequence of additional layers made from various materials that are intended for various purposes, such as, for example, dielectric layers, blocker layer, growth layer or any combination thereof.

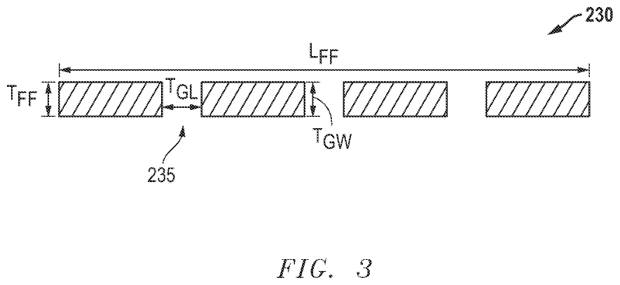

It will be appreciated that for purposes of embodiments described herein, a film or layer is considered discontinuous if it includes at least one discontinuity (i.e., a crack, gap or space in the film or layer) that passes entirely through the thickness of the film or layer and has sufficient dimensions (i.e., length and width) to allow that layers (or material from the layers) which encapsulate the film having the discontinuity to contact each other through the discontinuity. For purposes of illustration, FIG. 3 includes an illustration of cross-sectional view of a portion of a discontinuous functional film 230. As shown in FIG. 3, the discontinuous silver-based functional film 230 may have a length L_{FF} and an average thickness T_{FF}. Further, as shown in FIG. 3, the discontinuous silver-based functional film 230 may have at least one discontinuity 235. As noted above and as shown in FIG. 3, each of the discontinuities 235 may pass through the entire thickness T_{FF} of the discontinuous silver-based functional film 230 and may have a particular gap length T_{GL} and a particular gap width T_{GW}. Further, according to particular embodiments, a discontinuity 235 must also be of a sufficient size (i.e., have a sufficient gap length T_{GL}) such that materials from the layers surrounding both sides of the gap or space may come in contact with each other.

According to certain embodiments, a discontinuity 235 in the discontinuous silver-based functional film 230 may separate the discontinuous silver-based functional film 230 into distinct segments, meaning that the discontinuity 235 runs the entire width of the discontinuous silver-based functional film 230. According to still other embodiments, a discontinuity 234 of the discontinuous silver-based functional film 230 may meet not the film or layer into distinct segments (i.e., the discontinuity 235 resemble a hole in the discontinuous silver-based functional film 230, which does not run the entire width of the discontinuous silver-based functional film 230).

Referring back to FIG. 2, according to certain embodiments, the discontinuous silver-based functional film 230 may have at least one discontinuity having a dimension of a particular gap length T_{GL}. For example, the discontinuous silver-based functional film 230 may have at least one discontinuity having gap length T_{GL} of at least about 0.1 microns, such as, at least about 0.2 microns or at least about 0.3 microns or at least about 0.4 microns or at least about 0.5 microns or at least about 0.6 microns or at least about 0.7 microns or at least about 0.8 microns or at least about 0.9 microns or at least about 1 microns or at least about 2 microns or at least about 3 microns or at least about 4 microns or at least about 5 microns or at least about 6 microns or at least about 7 microns or at least about 8 microns or at least about 9 microns or at least about 10 microns or at least about 11 microns or at least about 12 microns or at least about 13 microns or at least about 14 microns or at least about 15 microns or at least about 16 microns or at least about 17 microns or at least about 18 microns or at least about 19 microns or at least about 20 microns or at least about 25 microns or at least about 30 microns or at least about 35 microns or at least about 40 microns or even at least about 50 microns. According to still other embodiments, the discontinuous silver-based functional film 230 may have at least one discontinuity having gap length T_{GL} of not greater an about 100 microns or not greater than about 90 microns or not greater than about 80 microns or not greater than about 70 microns or not greater than about 60 microns. It will be appreciated that the discontinuous silver-based functional film 230 may have at least one discontinuity having a gap length T_{GL} within a range between any of minimum and maximum values noted above. It will be further appreciated that the discontinuous silver-based functional film 230 may have at least one discontinuity having a gap length T_{GL} of any value between any of the minimum and maximum values noted above.

According to certain embodiments, the discontinuous silver-based functional film 230 may have at least one discontinuity having an average gap width T_{GW} of a particular size. For example, the discontinuous silver-based functional film 230 may have at least one discontinuity having an average gap width T_{GW} of at least about 10 microns, such as, at least about 11 microns or at least about 12 microns or at least about 13 microns or at least about 14 microns or at least about 15 microns or at least about 16 microns or at least about 17 microns or at least about 18 microns or at least about 19 microns or at least about 20 microns or at least about 25 microns or at least about 30 microns or at least about 35 microns or at least about 40 microns or even at least about 50 microns. According to still other embodiments, the discontinuous silver-based functional film 230 may have at least one discontinuity having an average gap width T_{GW} of not greater an about 100 microns or not greater than about 90 microns or not greater than about 80 microns or not greater than about 70 microns or not greater than about 60 microns. It will be appreciated that the discontinuous silver-based functional film 230 may have at least one discontinuity having an average gap width T_{GW} within a range between any of minimum and maximum values noted above. It will be further appreciated that the discontinuous silver-based functional film 230 may have at least one discontinuity having an average gap width T_{GW} of any value between any of the minimum and maximum values noted above.

According to still other embodiments, the discontinuous silver-based functional film 230 may have a particular number of discontinuities 235 as measured over a length of 1 cm of the functional film 230. For example, the discontinuous silver-based functional film 230 may have at least one discontinuity over a length of 1 cm of the functional film 230, such as, at least two discontinuities over a length of 1 cm of the functional film 230 or at least three discontinuities over a length of 1 cm of the functional film 230 or at least four discontinuities over a length of 1 cm of the functional film 230 or at least about five discontinuities over a length of 1 cm of the functional film 230 or at least six discontinuities over a length of 1 cm of the functional film 230 or at least seven discontinuities over a length of 1 cm of the functional film 230 or at least eight discontinuities over a length of 1 cm of the functional film 230 or at least nine discontinuities over a length of 1 cm of the functional film 230 or at least ten discontinuities over a length of 1 cm of the functional film 230.

According to still other embodiments, the discontinuities 235 of the discontinuous silver-based functional film 230 may have a regular distribution, meaning that the distances between the discontinuities 235 of the discontinuous silver-based functional film 230 are all the same. It will be appreciated that where the distances between the discontinuities 235 are regular, the discontinuities 235 may appear within the discontinuous silver-based function film as a pattern (i.e., more structured in shape and size). According to still other embodiments, the discontinuities 235 of the discontinuous silver-based functional film 230 may have an irregular distribution, meaning that at least two of the distances between the discontinuities 235 of the discontinuous silver-based functional film 230 are different. It will be appreciated that where the distances between the discontinuities 235 are irregular, the discontinuities 235 may appear within the discontinuous silver-based function film as a compilation of cracks or gaps of random sizes and random distributions.

According to yet other embodiments, the discontinuous silver-based functional film 230 may have a particular thickness T_{FF}. For example, the discontinuous silver-based functional film 230 may have an average thickness T_{FF} of at least about 5 nm, such as, at least about 10 nm or at least about 15 nm or at least about 20 nm or at least about 25 nm or at least about 30 nm or at least about 35 nm or at least about 40 nm or at least about 45 nm or at least about 50 nm or at least about 75 nm or at least about 100 nm or at least about 125 nm or at least about 150 nm or at least about 175 nm or at least about 200 nm or at least about 225 nm or even at least about 250 nm. According to still other embodiments, the discontinuous silver-based functional film 230 may have an average thickness T_{FF} of not greater than about 500 nm, such as, not greater than about 450 nm or not greater than about 400 nm or not greater than about 350 nm or even not greater than about 300 nm. It will be appreciated that the discontinuous silver-based functional film 230 may have an average thickness T_{FF} within a range between any of minimum and maximum values noted above. It will be further appreciated that the discontinuous silver-based functional film 230 may have an average thickness T_{FF} of any value between any of the minimum and maximum values noted above.

As noted herein, the discontinuous silver-based functional film 230 may include at least one silver-based functional layer. According to certain embodiments, the silver-based function layer of the discontinuous silver-based functional film 230 may have a particular thickness. For example, the silver-based function layer of the discontinuous silver-based functional film 230 may have an average thickness of at least about 4 nm, such as, at least about 5 nm or at least about 6 nm or at least about 7 nm or at least about 8 nm or at least about 9 nm or at least about 10 nm or at least about 11 nm or even at least about 12 nm. According to yet other embodiments, the silver-based function layer of the discontinuous silver-based functional film 230 may have an average thickness of not greater than about 20 nm or not greater than about 19 nm or not greater than about 18 nm or not greater than about 17 nm or not greater than about 16 nm or even not greater than about 15 nm. It will be appreciated that the silver-based function layer of the discontinuous silver-based functional film 230 may have an average thickness within a range between any of minimum and maximum values noted above. It will be further appreciated that the silver-based function layer of the discontinuous silver-based functional film 230 may have an average thickness of any value between any of the minimum and maximum values noted above.

According to still other embodiments, the discontinuous silver-based functional film 230 may have a particular functional film VLT. For example, the discontinuous silver-based functional film 230 may have a functional film VLT of at least about 1%, such as, at least about 5% or at least about 10% or at least about 15% or at least about 25% or at least about 30% or at least about 35% or at least about 40% or at least about 45% or at least about 50% or at least about 55% or at least about 60% or at least about 65% or at least about 70% or even at least about 75%. According to still other embodiments, the discontinuous silver-based functional film 230 may have a functional film VLT of not greater than about 99%. It will be appreciated that the discontinuous silver-based functional film 230 may have a functional film VLT within a range between any of minimum and maximum values noted above. It will be further appreciated that the discontinuous silver-based functional film 230 may have a functional film VLT of any value between any of the minimum and maximum values noted above.

According to still other embodiments, the discontinuous silver-based functional film 230 may have a particular functional film VLR. For example, the discontinuous silver-based functional film 230 may have a functional film VLR of at least about 1%, such as, at least about 3% or at least about 5% or even at least about 7%. According to still other embodiments, the discontinuous silver-based functional film 230 may have a functional film VLR of not greater than about 95%, such as, not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the discontinuous silver-based functional film 230 may have a functional film VLR within a range between any of minimum and maximum values noted above. It will be further appreciated that the discontinuous silver-based functional film 230 may have a functional film VLR of any value between any of the minimum and maximum values noted above.

According to still other embodiments, the discontinuous silver-based functional film 230 may have a particular functional film VLA. For example, the discontinuous silver-based functional film 230 may have a functional film VLA of at least about 1%, such as, at least about 3% or at least about 5% or even at least about 7%. According to still other embodiments, the discontinuous silver-based functional film 230 may have a functional film VLA of not greater than about 95%, such as, not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the discontinuous silver-based functional film 230 may have a functional film VLA within a range between any of minimum and maximum values noted above. It will be further appreciated that the discontinuous silver-based functional film 230 may have a functional film VLA of any value between any of the minimum and maximum values noted above.

According to still other embodiments, the discontinuous silver-based functional film 230 may have a particular functional film TE. For example, the discontinuous silver-based functional film 230 may have a functional film TE of at least about 2%, such as, at least about 5% or at least about 10% or at least about 25% or at least about 35% or even at least about 40%. According to still other embodiments, the discontinuous silver-based functional film 230 may have a functional film TE of not greater than about 80%, such as, not greater than about 70% or even not greater than about 60%. It will be appreciated that the discontinuous silver-based functional film 230 may have a functional film TE within a range between any of minimum and maximum values noted above. It will be further appreciated that the discontinuous silver-based functional film 230 may have a functional film TE of any value between any of the minimum and maximum values noted above.

According to still other embodiments, the discontinuous silver-based functional film 230 may have a particular functional film RE. For example, the discontinuous silver-based functional film 230 may have a functional film RE of at least about 10%, such as, at least about 15% or at least about 20%. According to still other embodiments, the discontinuous silver-based functional film 230 may have a functional film RE of not greater than about 70%, such as, not greater than about 60% or not greater than about 50% or not greater than about 40% or even not greater than about 30%. It will be appreciated that the discontinuous silver-based functional film 230 may have a functional film RE within a range between any of minimum and maximum values noted above. It will be further appreciated that the discontinuous silver-based functional film 230 may have a functional film RE of any value between any of the minimum and maximum values noted above.

According to still other embodiments, the discontinuous silver-based functional film 230 may have a particular functional film TTS. For example, the discontinuous silver-based functional film 230 may have a functional film TTS of at least about 10%, such as, at least about 25% or at least about 35% or even at least about 40%. According to still other embodiments, the discontinuous silver-based functional film 230 may have a functional film TTS of not greater than about 80%, such as, not greater than about 70% or even not greater than about 60%. It will be appreciated that the discontinuous silver-based functional film 230 may have a functional film TTS within a range between any of minimum and maximum values noted above. It will be further appreciated that the discontinuous silver-based functional film 230 may have a functional film TTS of any value between any of the minimum and maximum values noted above.

According to yet other embodiments, the over-layer 220 may have a particular thickness. For example, the over-layer 220 may have an average thickness of at least about 0.015 mm, such as, at least about 0.02 mm or at least about 0.025 mm or at least about 0.03 mm or at least about 0.035 mm or at least about 0.04 mm or at least about 0.045 mm or at least about 0.05 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to still other embodiments, the over-layer 220 may have an average thickness of not greater than about 3 mm, such as, not greater than about 2.5 mm or not greater than about 2.0 mm or not greater than about 1.5 mm or not greater than about 1.0 mm not greater than about 0.9 mm or even not greater than about 0.8 mm. It will be appreciated that the over-layer 220 may have an average thickness within a range between any of minimum and maximum values noted above. It will be further appreciated that the over-layer 220 may have an average thickness of any value between any of the minimum and maximum values noted above.

Referring back to FIG. 2, the over-layer 220 may have a first surface 222 that may contact the discontinuous silver-based functional film 230.

According to certain embodiments, the first surface 222 of the over-layer 220 may have a particular average surface roughness. For example, the first surface 222 of the over-layer 220 may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the first surface 222 of the over-layer 220 may have an average surface roughness of not greater than about 200 microns, such as, not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or even not greater than about 60 microns. It will be appreciated that the first surface 222 of the over-layer 220 may have an average surface roughness within a range between any of minimum and maximum values noted above. It will be further appreciated that the first surface 222 of the over-layer 220 may have an average surface roughness of any value between any of the minimum and maximum values noted above.

Referring back to FIG. 2, the over-layer 220 may have a second surface 224 that does not contact the discontinuous silver-based functional film 230. According to certain embodiments, the second surface 224 of the over-layer 220 may have a particular average surface roughness. For example, the second surface 224 of the over-layer 220 may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the second surface 224 of the over-layer 220 may have an average surface roughness of not greater than about 200 microns, such as, not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or even not greater than about 60 microns. It will be appreciated that the second surface 224 of the over-layer 220 may have an average surface roughness within a range between any of minimum and maximum values noted above. It will be further appreciated that the second surface 224 of the over-layer 220 may have an average surface roughness of any value between any of the minimum and maximum values noted above.

According to still other embodiments, the composite film 200 may have a particular thickness. For example, the composite film 200 may have an average thickness of at least about 0.03 mm, such as, at least about 0.04 mm or at least about 0.05 mm or at least about 0.06 mm or at least about 0.07 mm or at least about 0.08 mm or at least about 0.09 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to yet other embodiments, the composite film 200 may have an average thickness of not greater than about 2 mm or not greater than about 1.5 mm or not greater than about 1 mm. It will be appreciated that the composite film 200 may have an average thickness within a range between any of minimum and maximum values noted above. It will be further appreciated that the composite film 200 may have an average thickness of any value between any of the minimum and maximum values noted above.

According to yet other embodiments, the composite film 200 may have a particular R/sq value. For example, the composite film 200 may have an R/sq value or at least about 10 Ohm/sq, such as, at least about 20 Ohm/sq or at least about 30 Ohm/sq or at least about 40 Ohm/sq or at least about 50 Ohm/sq or at least about 60 Ohm/sq or at least about 70 Ohm/sq or at least about 80 Ohm/sq or at least about 90 Ohm/sq or at least about 100 Ohm/sq or at least about 110 Ohm/sq or at least about 120 Ohm/sq or at least about 130 Ohm/sq or at least about 140 Ohm/sq or at least about 150 Ohm/sq or at least about 160 Ohm/sq or at least about 170 Ohm/sq or at least about 180 Ohm/sq or at least about 190 Ohm/sq or at least about 200 Ohm/sq or at least about 210 Ohm/sq or at least about 220 Ohm/sq or at least about 230 Ohm/sq or at least about 240 Ohm/sq or even at least about 250 Ohm/sq. It will be appreciated that the composite film 200 may have an R/sq value between any of values noted above. It will be further appreciated that the composite film 200 may have an R/sq value of any value between any of the values noted above.

Alternative embodiments described herein are generally directed to laminate of a composite film and methods of forming the laminate. According to particular embodiments, such a laminate may be formed by laminating a composite film 200 formed according to embodiments described herein, between a first substrate and a second substrate. According to particular embodiments described herein, such laminates may have particular performance characteristics, such as, high visible light transmittance, low TTS and high RF transparency (i.e., a high R/sq value).

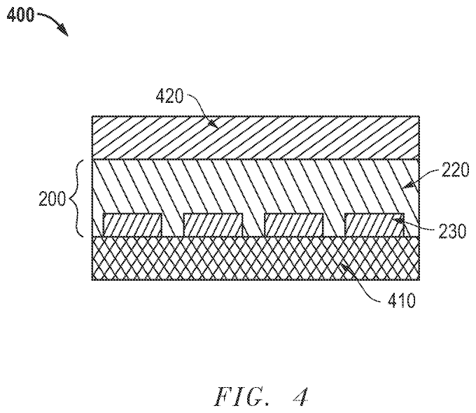

For purposes of illustrate, FIG. 4 includes an illustration of a cross-sectional view of a portion of an embodiment of a laminate 400 formed according to embodiments described herein. As shown in FIG. 4, a laminate 400 may include a first substrate 410, a second substrate 420 and a composite film 200 between the first substrate 410 and the second substrate 410. As shown in FIG. 4, the composite film 200 may include a discontinuous silver-based functional film 230, and an over-layer 220 overlying the discontinuous silver-based functional film 220, where the over-layer 220 includes TPU. Described another way and as also shown in FIG. 4, a laminate 400 may include a first substrate 410, a discontinuous silver-based functional film 230 overlying the first substrate 410, an over-layer 220 overlying the discontinuous silver-based functional film 220, and a second substrate 420 overlying the over-layer 220.

According to particular embodiments, the first substrate 410 may include a polymer material. According to another particular embodiment, the first substrate 410 may consist of a polymer material. According to still other embodiments, the first substrate 410 may be a polymer substrate layer. According to particular embodiments, the polymer substrate layer may include any desirable polymer material.

According to still other embodiments, the first substrate 410 may include a polyethylene terephthalate (PET) material. According to another particular embodiment, the first substrate 410 may consist of a PET material. According to still other embodiments, the first substrate 410 may be a PET substrate layer. According to particular embodiments, the PET substrate layer may include any desirable polymer material.

According to yet another embodiment, the first substrate 410 may include a glass material. According to yet another embodiment, the first substrate 410 may consist of a glass material. According to still another embodiment, the first substrate 410 may be a glass substrate layer. According to still other embodiments, the glass material may include any desirable glass material.

It will be further appreciated that when the first substrate 410 is a glass substrate layer.

According to certain embodiments, the first substrate 410 may have a particular thickness. For example, the first substrate 410 may have an average thickness of at least about 0.2 mm, such as, at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.5 mm or at least about 2.0 mm or even at least about 2.5 mm. According to still other embodiments, the first substrate 410 may have an average thickness of not greater than about 19 mm, such as, not greater than about 18 mm or not greater than about 17 mm or not greater than about 16 mm or not greater than about 15 mm or not greater than about 14 mm or not greater than about 13 mm or not greater than about 12 mm or not greater than about 11 mm or not greater than about 10 mm or not greater than about 9 mm or not greater than about 8 mm or not greater than about 7 mm or not greater than about 6 mm or not greater than about 5 mm or not greater than about 4 mm or not greater than about 3.75 mm or not greater than about 3.5 mm or not greater than about 3.25 mm or not greater than about 3.0 mm. It will be appreciated that the first substrate 410 may have an average thickness within a range between any of minimum and maximum values noted above. It will be further appreciated that the first substrate 410 may have an average thickness of any value between any of the minimum and maximum values noted above.

According to particular embodiments, the second substrate 420 may include a polymer material. According to another particular embodiment, the second substrate 420 may consist of a polymer material. According to still other embodiments, the second substrate 420 may be a polymer substrate layer. According to particular embodiments, the polymer substrate layer may include any desirable polymer material.

According to still other embodiments, the second substrate 420 may include a polyethylene terephthalate (PET) material. According to another particular embodiment, the second substrate 420 may consist of a PET material. According to still other embodiments, the second substrate 420 may be a PET substrate layer. According to particular embodiments, the PET substrate layer may include any desirable polymer material.

According to yet another embodiment, the second substrate 420 may include a glass material. According to yet another embodiment, the second substrate 420 may consist of a glass material. According to still another embodiment, the second substrate 420 may be a glass substrate layer. According to still other embodiments, the glass material may include any desirable glass material.

It will be further appreciated that when the second substrate 420 is a glass substrate layer.

According to certain embodiments, the second substrate 420 may have a particular thickness. For example, the second substrate 420 may have an average thickness of at least about 0.5 mm, such as, at least about 0.6 mm or at least about 0.7 mm or at least about 0.8 mm or at least about 0.9 mm or at least about 1.0 mm or at least about 1.5 mm or at least about 2.0 mm or even at least about 2.5 mm. According to still other embodiments, the second substrate 420 may have an average thickness of not greater than about 19 mm, such as, not greater than about 18 mm or not greater than about 17 mm or not greater than about 16 mm or not greater than about 15 mm or not greater than about 14 mm or not greater than about 13 mm or not greater than about 12 mm or not greater than about 11 mm or not greater than about 10 mm or not greater than about 9 mm or not greater than about 8 mm or not greater than about 7 mm or not greater than about 6 mm or not greater than about 5 mm or not greater than about 4 mm or not greater than about 3.75 mm or not greater than about 3.5 mm or not greater than about 3.25 mm or not greater than about 3.0 mm. It will be appreciated that the second substrate 420 may have an average thickness within a range between any of minimum and maximum values noted above. It will be further appreciated that the second substrate 420 may have an average thickness of any value between any of the minimum and maximum values noted above.

According to still other embodiments, the laminate 400 may have a particular thickness. For example, the laminate 400 may have an average thickness of at least about 1.0 mm, such as, at least about 2.0 mm or even at least about 3.0 mm. According to still other embodiment, the laminate 400 may have an average thickness of not greater than about 38 mm, such as, not greater than about 37 mm or not greater than about 36 mm or not greater than about 35 mm or not greater than about 34 mm or not greater than about 33 mm or not greater than about 32 mm or not greater than about 31 mm or not greater than about 30 mm or not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 20 mm or not greater than about 19 mm or not greater than about 18 mm or not greater than about 17 mm or not greater than about 16 mm or not greater than about 15 mm or not greater than about 14 mm or not greater than about 13 mm or not greater than about 12 mm or not greater than about 11 mm or not greater than about 10 mm or not greater than about 9 mm or not greater than about 8 mm or not greater than about 7 mm or even not greater than about 6 mm. It will be appreciated that the laminate 400 may have an average thickness within a range between any of minimum and maximum values noted above. It will be further appreciated that the laminate 400 may have an average thickness of any value between any of the minimum and maximum values noted above.

According to yet other embodiments, the laminate 400 may have a particular R/sq value. For example, the laminate 400 may have an R/sq value or at least about 10 Ohm/sq, such as, at least about 20 Ohm/sq or at least about 30 Ohm/sq or at least about 40 Ohm/sq or at least about 50 Ohm/sq or at least about 60 Ohm/sq or at least about 70 Ohm/sq or at least about 80 Ohm/sq or at least about 90 Ohm/sq or at least about 100 Ohm/sq or at least about 110 Ohm/sq or at least about 120 Ohm/sq or at least about 130 Ohm/sq or at least about 140 Ohm/sq or at least about 150 Ohm/sq or at least about 160 Ohm/sq or at least about 170 Ohm/sq or at least about 180 Ohm/sq or at least about 190 Ohm/sq or at least about 200 Ohm/sq or at least about 210 Ohm/sq or at least about 220 Ohm/sq or at least about 230 Ohm/sq or at least about 240 Ohm/sq or even at least about 250 Ohm/sq. It will be appreciated that the laminate 400 may have an R/sq value between any of values noted above. It will be further appreciated that the laminate 400 may have an R/sq value of any value between any of the values noted above.

According to still other embodiments, the laminate 400 may have a particular laminate VLT. It will be appreciated that the laminate VLT may be dependent on the clarity of the outer layers in the laminate (i.e., the clarity of the TPU layer or the glazings). For example, where the laminate 400 includes clear TPU layers (and other glazings), the laminate 400 may have a laminate VLT of at least about 1%, such as, at least about 5% or at least about 10% or at least about 15% or at least about 20% or at least about 25% or at least about 30% or at least about 35% or at least about 40% or at least about 45% or at least about 50% or at least about 55% or at least about 60% or at least about 65% or at least about 70% or even at least about 75%. According to still other embodiments, the laminate 400 may have a laminate VLT of not greater than about 99%. It will be appreciated that the laminate 400 may have a laminate VLT within a range between any of minimum and maximum values noted above. It will be further appreciated that the laminate 400 may have a laminate VLT of any value between any of the minimum and maximum values noted above.

It will further be appreciated that the composite film 200 may be used in a laminate with non-clear materials (i.e., dark substrate or TPU layers). In such applications, the laminate VLT may be low, for example, not greater than about 30%, such as, not greater than about 25% or not greater than about 20% or not greater than about 15% or not greater than about 10% or not greater than about 9% or not greater than about 8% or not greater than about 7% or not greater than about 6% or even not greater than about 5%.

According to still other embodiments, the laminate 400 may have a particular laminate VLR. For example, the laminate 400 may have a laminate VLR of at least about 1%, such as, at least about 3% or at least about 5% or even at least about 7%. According to still other embodiments, the laminate 400 may have a laminate VLR of not greater than about 99%, such as, not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the laminate 400 may have a laminate VLR within a range between any of minimum and maximum values noted above. It will be further appreciated that the laminate 400 may have a laminate VLR of any value between any of the minimum and maximum values noted above.

According to still other embodiments, the laminate 400 may have a particular laminate VLA. For example, the laminate 400 may have a laminate VLA of at least about 1%, such as, at least about 3% or at least about 5% or even at least about 7%. According to still other embodiments, the laminate 400 may have a laminate VLA of not greater than about 95%, such as, not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the laminate 400 may have a laminate VLA within a range between any of minimum and maximum values noted above. It will be further appreciated that the laminate 400 may have a laminate VLA of any value between any of the minimum and maximum values noted above.

According to still other embodiments, the laminate 400 may have a particular laminate TE. For example, the laminate 400 may have a laminate TE of at least about 2%, such as, at least about 2% or at least about 5% or at least about 10% or at least about 25% or at least about 35% or even at least about 40%. According to still other embodiments, the laminate 400 may have a laminate TE of not greater than about 80%, such as, not greater than about 70% or even not greater than about 60%. It will be appreciated that the laminate 400 may have a laminate TE within a range between any of minimum and maximum values noted above. It will be further appreciated that the laminate 400 may have a laminate TE of any value between any of the minimum and maximum values noted above.

According to still other embodiments, the laminate 400 may have a particular laminate RE. For example, the laminate 400 may have a laminate RE of at least about 10%, such as, at least about 15% or at least about 20%. According to still other embodiments, the laminate 400 may have a laminate RE of not greater than about 70%, such as, not greater than about 60% or not greater than about 50% or not greater than about 40% or even not greater than about 30%. It will be appreciated that the laminate 400 may have a laminate RE within a range between any of minimum and maximum values noted above. It will be further appreciated that the laminate 400 may have a laminate RE of any value between any of the minimum and maximum values noted above.

According to still other embodiments, the laminate 400 may have a particular laminate TTS. For example, the laminate 400 may have a laminate TTS of at least about 10%, such as, at least about 25% or at least about 35% or even at least about 40%. According to still other embodiments, the laminate 400 may have a laminate TTS of not greater than about 80%, such as, not greater than about 70% or even not greater than about 60%. It will be appreciated that the laminate 400 may have a laminate TTS within a range between any of minimum and maximum values noted above. It will be further appreciated that the laminate 400 may have a laminate TTS of any value between any of the minimum and maximum values noted above.

Additional embodiments described herein are generally directed to composite films and methods of forming composite films that include an under-layer, a discontinuous silver-based functional film overlying the under-layer, and an over-layer overlying the discontinuous silver-based functional film. The under-layer may include TPU and the over-layer may include TPU. According to particular embodiments described herein, such composite films may have particular performance characteristics, such as, high visible light transmittance, low TTS and high RF transparency (i.e., a high R/sq value).

These concepts are better understood in view of the embodiments described below that illustrate and do not limit the scope of the present disclosure.

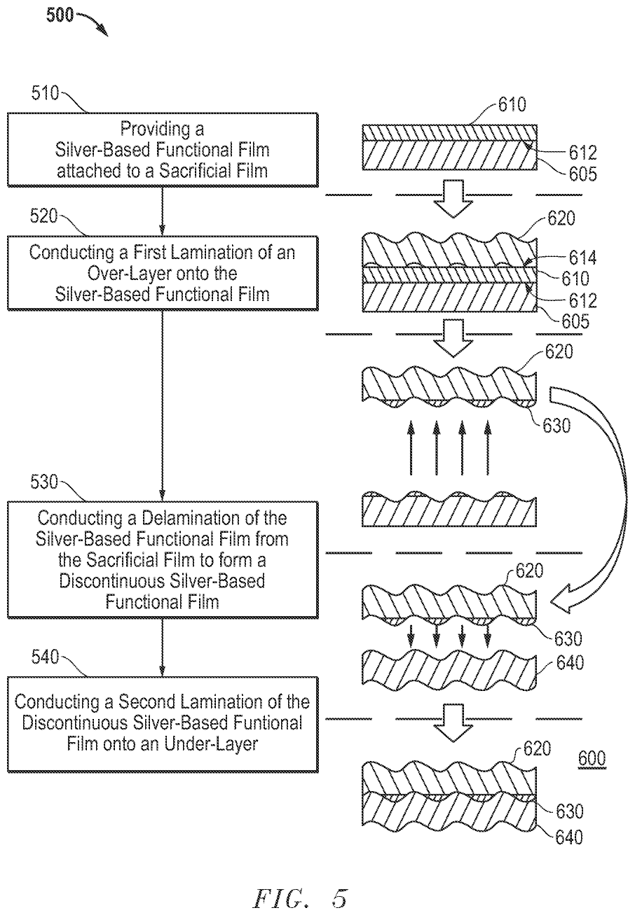

Referring first to methods of forming composite films according to embodiments described herein, FIG. 5 includes a diagram demonstrating a composite film formation method 500 for forming a composite film 600. According to particular embodiments, and as shown in FIG. 5, the composite film formation method 500 may include a first step 510 of providing a silver-based functional film 610 with a first surface 612 attached to a sacrificial film 605, a second step 520 of conducting a first lamination of an over-layer 620 onto a second surface 614 of the silver-based functional film 610, where the over-layer 620 includes TPU and where the silver-based functional film 610 is between the over-layer 620 and the sacrificial film 605, a third step 530 of conducting a delamination of the silver-based functional film 610 from the sacrificial film 605 to form a discontinuous silver-based functional film 630 attached to the over-layer 620, and a fourth step 540 of conducting a second lamination of the discontinuous silver-based functional film 630 attached to the over-layer 620 onto an under-layer 640 to form the composite film 600, where the under-layer 640 includes TPU and where the discontinuous silver-based functional film 630 is between the over-layer 620 and the under-layer 640.

Regarding the first step 510 of providing a silver-based functional film 610 with a first surface 612 attached to a sacrificial film 605, according to certain embodiments, the silver-based functional film 610 that is attached to the sacrificial film 605 may be a single silver-based functional layer. According to still other embodiments, the silver-based functional film 610 that is attached to the sacrificial film 605 may be a multi-layer composite film that includes at least one silver-based functional layer. It will be appreciated that the silver-based functional film 610 that is attached to the sacrificial film 605 may be a multi-layer composite film that further includes a sequence of additional layers made from various materials that are intended for various purposes, such as, for example, dielectric layers, blocker layer, growth layer or any combination thereof.

According to still other embodiments, the sacrificial film 605 may include a polyethylene terephthalate (PET) material. According to another particular embodiment, the sacrificial film 605 may consist of a PET material. According to still other embodiments, the sacrificial film 605 may be a PET film.

Now regarding second step 520 of conducting a first lamination of an over-layer 220 onto a second surface 614 of the silver-based functional film 610, wherein the over-layer includes TPU and where the silver-based functional film 610 is between the over-layer 620 and the sacrificial film 605, according to certain embodiments, the over-layer 620 used in the first lamination step may have a particular thickness. For example, the over-layer 620 used in the first lamination step may have an average thickness of at least about 0.015 mm, such as, at least about 0.02 mm or at least about 0.025 mm or at least about 0.03 mm or at least about 0.035 mm or at least about 0.04 mm or at least about 0.045 mm or at least about 0.05 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to still other embodiments, the over-layer 620 used in the first lamination step may have an average thickness of not greater than about 3 mm, such as, not greater than about 2.5 mm or not greater than about 2.0 mm or not greater than about 1.5 mm or not greater than about 1 mm or not greater than about 0.9 mm or even not greater than about 0.8 mm. It will be appreciated that the over-layer 620 used in the first lamination step may have an average thickness within a range between any of minimum and maximum values noted above. It will be further appreciated that the over-layer 620 used in the first lamination step may have an average thickness of any value between any of the minimum and maximum values noted above.

According to other embodiments, a first surface of the over-layer 620 used in the first lamination step may have a particular average surface roughness. For example, the first surface of the over-layer 620 used in the first lamination step may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the first surface 622 of the over-layer 620 used in the first lamination step may have an average surface roughness of not greater than about 200 microns, such as, not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns not greater than about 90 microns or not greater than about 80 microns or not greater than about 70 microns or even not greater than about 60 microns. It will be appreciated that the first surface of the over-layer 620 used in the first lamination step may have an average surface roughness within a range between any of minimum and maximum values noted above. It will be further appreciated that the first surface of the over-layer 620 used in the first lamination step may have an average surface roughness of any value between any of the minimum and maximum values noted above.

According to still other embodiments, the over-layer 620 used in the first lamination step may have a second surface 624 that does not contact the discontinuous silver-based functional film 630. According to certain embodiments, the second surface 624 of the over-layer 620 used in the first lamination step may have a particular average surface roughness. For example, the second surface 624 of the over-layer 620 used in the first lamination step may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the second surface 624 of the over-layer 620 used in the first lamination step may have an average surface roughness of not greater than about 200 microns, such as, not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns not greater than about 90 microns or not greater than about 80 microns or not greater than about 70 microns or even not greater than about 60 microns. It will be appreciated that the second surface 624 of the over-layer 620 used in the first lamination step may have an average surface roughness within a range between any of minimum and maximum values noted above. It will be further appreciated that the second surface 624 of the over-layer 620 used in the first lamination step may have an average surface roughness of any value between any of the minimum and maximum values noted above.

Regarding third step 530 of conducting a delamination of the silver-based functional film 610 from the sacrificial film 605 to form a discontinuous silver-based functional film 630 attached to the over-layer 620, according to certain embodiments, the discontinuous silver-based functional film 630 formed through the delamination step may be a single silver-based functional layer. According to still other embodiments, the discontinuous silver-based functional film 630 formed through the delamination step may be a multi-layer composite film that includes at least one silver-based functional layer. It will be appreciated that the discontinuous silver-based functional film 630 formed through the delamination step may be a multi-layer composite film that further includes a sequence of additional layers made from various materials that are intended for various purposes, such as, for example, dielectric layers, blocker layer, growth layer or any combination thereof.

Now regarding fourth step 540 of conducting a second lamination of the discontinuous silver-based functional film 630 attached to the over-layer 620 onto a under-layer 640 to form the composite film 600, wherein the discontinuous silver-based functional film 630 is between the over-layer 620 and the under-layer 640, according to certain embodiments, the under-layer 640 used in the second lamination step may have a particular thickness. For example, the under-layer 640 used in the second lamination step may have an average thickness of at least about 0.015 mm, such as, at least about 0.02 mm or at least about 0.025 mm or at least about 0.03 mm or at least about 0.035 mm or at least about 0.04 mm or at least about 0.045 mm or at least about 0.05 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to still other embodiments, the under-layer 640 used in the second lamination step may have an average thickness of not greater than about 3 mm, such as, not greater than about 2.5 mm or not greater than about 2.0 mm or not greater than about 1.5 mm or not greater than about 1.0 mm not greater than about 0.9 mm or even not greater than about 0.8 mm. It will be appreciated that the under-layer 640 used in the second lamination step may have an average thickness within a range between any of minimum and maximum values noted above. It will be further appreciated that the under-layer 640 used in the second lamination step may have an average thickness of any value between any of the minimum and maximum values noted above.

According to other embodiments, a first surface 642 of the under-layer 640 used in the second lamination step may have a particular average surface roughness. For example, the first surface of the under-layer 640 used in the second lamination step may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the first surface 642 of the under-layer 640 used in the second lamination step may have an average surface roughness of not greater than about 100 microns, such as, not greater than about 90 microns or not greater than about 80 microns or not greater than about 70 microns or even not greater than about 60 microns. It will be appreciated that the first surface of the under-layer 640 used in the second lamination step may have an average surface roughness within a range between any of minimum and maximum values noted above. It will be further appreciated that the first surface 642 of the under-layer 640 used in the second lamination step may have an average surface roughness of any value between any of the minimum and maximum values noted above.

According to still other embodiments, the under-layer 640 used in the second lamination step may have a second surface 644 that does not contact the discontinuous silver-based functional film 630. According to certain embodiments, the second surface of the under-layer 640 used in the second lamination step may have a particular average surface roughness. For example, the second surface 644 of the under-layer 640 used in the second lamination step may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the second surface of the under-layer 640 used in the second lamination step may have an average surface roughness of not greater than about 100 microns, such as, not greater than about 90 microns or not greater than about 80 microns or not greater than about 70 microns or even not greater than about 60 microns. It will be appreciated that the second surface of the under-layer 640 used in the second lamination step may have an average surface roughness within a range between any of minimum and maximum values noted above. It will be further appreciated that the second surface 644 of the under-layer 640 used in the second lamination step may have an average surface roughness of any value between any of the minimum and maximum values noted above.

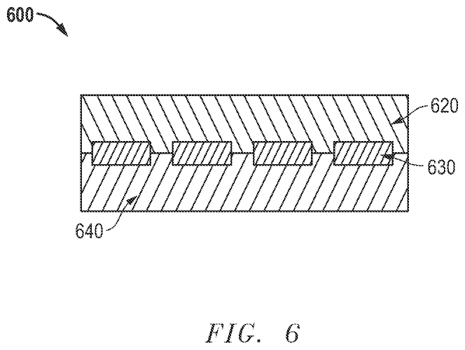

Referring now to the composite film 600 formed according to embodiments described herein, the composite film 600 may have a particular structure. FIG. 6 includes an illustration of a cross-sectional view of a portion of an embodiment of a composite film 600. As shown in FIG. 6, the composite film 600 may include an under-layer 640, a discontinuous silver-based functional film 630 overlying the under-layer 640, and an over-layer 620 overlying the discontinuous silver-based functional film 630. The under-layer 640 may include TPU and the over-layer 620 may include TPU.

According to particular embodiments, the discontinuous silver-based functional film 630 may be a single silver-based functional layer. According to still other embodiments, the discontinuous silver-based functional film 630 may be a multi-layer composite film that includes at least one silver-based functional layer. It will be appreciated that the discontinuous silver-based functional film 630 may be a multi-layer composite film that further includes a sequence of additional layers made from various materials that are intended for various purposes, such as, for example, dielectric layers, blocker layer, growth layer or any combination thereof.

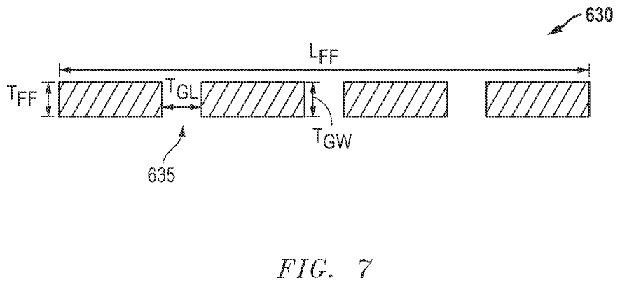

It will be appreciated that for purposes of embodiments described herein, a film or layer is considered discontinuous if it includes at least one discontinuity (i.e., a crack, gap or space in the film or layer) that passes entirely through the thickness of the film or layer and has sufficient dimensions (i.e., length and width) to allow that layers (or material from the layers) which encapsulate the film having the discontinuity to contact each other through the discontinuity. For purposes of illustration, FIG. 7 includes an illustration of cross-sectional view of a portion of a discontinuous functional film 630. As shown in FIG. 7, the discontinuous silver-based functional film 630 may have a length L_{FF} and an average thickness T_{FF}. Further, as shown in FIG. 7, the discontinuous silver-based functional film 630 may have at least one discontinuity 635. As noted above and as shown in FIG. 7, each of the discontinuities 635 may pass through the entire thickness T_{FF} of the discontinuous silver-based functional film 630 and may have a particular gap length T_{GL} and a particular gap width T_{GW}. Further, according to particular embodiments, a discontinuity 635 must also be of a sufficient size (i.e., have a sufficient gap length T_{GL}) such that materials from the layers surrounding both sides of the gap or space may come in contact with each other.

According to certain embodiments, a discontinuity 635 in the discontinuous silver-based functional film 630 may separate the discontinuous silver-based functional film 630 into distinct segments, meaning that the discontinuity 635 runs the entire width of the discontinuous silver-based functional film 630. According to still other embodiments, a discontinuity 635 of the discontinuous silver-based functional film 630 may meet not the film or layer into distinct segments (i.e., the discontinuity 635 resemble a hole in the discontinuous silver-based functional film 630, which does not run the entire width of the discontinuous silver-based functional film 630).

Referring back to FIG. 6 according to certain embodiments, the discontinuous silver-based functional film 630 may have at least one discontinuity having a dimension of a particular gap length T_{GL}. For example, the discontinuous silver-based functional film 630 may have at least one discontinuity having gap length T_{GL} of at least about 0.1 microns, such as, at least about 0.2 microns or at least about 0.3 microns or at least about 0.4 microns or at least about 0.5 microns or at least about 0.6 microns or at least about 0.7 microns or at least about 0.8 microns or at least about 0.9 microns or at least about 1 microns or at least about 2 microns or at least about 3 microns or at least about 4 microns or at least about 5 microns or at least about 6 microns or at least about 7 microns or at least about 8 microns or at least about 9 microns or at least about 10 microns or at least about 11 microns or at least about 12 microns or at least about 13 microns or at least about 14 microns or at least about 15 microns or at least about 16 microns or at least about 17 microns or at least about 18 microns or at least about 19 microns or at least about 20 microns or at least about 25 microns or at least about 30 microns or at least about 35 microns or at least about 40 microns or even at least about 50 microns. According to still other embodiments, the discontinuous silver-based functional film 630 may have at least one discontinuity having gap length T_{GL} of not greater an about 100 microns or not greater than about 90 microns or not greater than about 80 microns or not greater than about 70 microns or not greater than about 60 microns. It will be appreciated that the discontinuous silver-based functional film 630 may have at least one discontinuity having a gap length T_{GL} within a range between any of minimum and maximum values noted above. It will be further appreciated that the discontinuous silver-based functional film 630 may have at least one discontinuity having a gap length T_{GL} of any value between any of the minimum and maximum values noted above.

According to certain embodiments, the discontinuous silver-based functional film 630 may have at least one discontinuity having an average gap width T_{GW} of a particular size. For example, the discontinuous silver-based functional film 630 may have at least one discontinuity having an average gap width T_{GW} of at least about 10 microns, such as, at least about 11 microns or at least about 12 microns or at least about 13 microns or at least about 14 microns or at least about 15 microns or at least about 16 microns or at least about 17 microns or at least about 18 microns or at least about 19 microns or at least about 20 microns or at least about 25 microns or at least about 30 microns or at least about 35 microns or at least about 40 microns or even at least about 50 microns. According to still other embodiments, the discontinuous silver-based functional film 630 may have at least one discontinuity having an average gap width T_{GW} of not greater an about 100 microns or not greater than about 90 microns or not greater than about 80 microns or not greater than about 70 microns or not greater than about 60 microns. It will be appreciated that the discontinuous silver-based functional film 630 may have at least one discontinuity having an average gap width T_{GW} within a range between any of minimum and maximum values noted above. It will be further appreciated that the discontinuous silver-based functional film 630 may have at least one discontinuity having an average width of any value between any of the minimum and maximum values noted above.

According to still other embodiments, the discontinuous silver-based functional film 630 may have a particular number of discontinuities 635 as measured over a length of 1 cm of the functional film 635. For example, the discontinuous silver-based functional film 630 may have at least one discontinuity over a length of 1 cm of the functional film 635, such as, at least two discontinuities over a length of 1 cm of the functional film 635 or at least three discontinuities over a length of 1 cm of the functional film 635 or at least four discontinuities over a length of 1 cm of the functional film 635 or at least about five discontinuities over a length of 1 cm of the functional film 635 or at least six discontinuities over a length of 1 cm of the functional film 635 or at least seven discontinuities over a length of 1 cm of the functional film 635 or at least eight discontinuities over a length of 1 cm of the functional film 635 or at least nine discontinuities over a length of 1 cm of the functional film 635 or at least ten discontinuities over a length of 1 cm of the functional film 635.

According to still other embodiments, the discontinuities 635 of the discontinuous silver-based functional film 630 may have a regular distribution, meaning that the distances between the discontinuities 635 of the discontinuous silver-based functional film 630 are all the same. It will be appreciated that where the distances between the discontinuities 635 are regular, the discontinuities 635 may appear within the discontinuous silver-based function film as a pattern (i.e., more structured in shape and size). According to still other embodiments, the discontinuities 635 of the discontinuous silver-based functional film 630 may have an irregular distribution, meaning that at least two of the distances between the discontinuities 635 of the discontinuous silver-based functional film 630 are different. It will be appreciated that where the distances between the discontinuities 635 are irregular, the discontinuities 635 may appear within the discontinuous silver-based function film as a compilation of cracks or gaps of random sizes and random distributions.

According to yet other embodiments, the discontinuous silver-based functional film 630 may have a particular thickness T_{FF}. For example, the discontinuous silver-based functional film 630 may have an average thickness T_{FF} of at least about 10 nm, such as, at least about 15 nm or at least about 20 nm or at least about 25 nm or at least about 30 nm or at least about 35 nm or at least about 40 nm or at least about 45 nm or at least about 50 nm or at least about 75 nm or at least about 100 nm or at least about 125 nm or at least about 150 nm or at least about 175 nm or at least about 200 nm or at least about 225 nm or even at least about 250 nm. According to still other embodiments, the discontinuous silver-based functional film 630 may have an average thickness T_{FF} of not greater than about 500 nm, such as, not greater than about 450 nm or not greater than about 400 nm or not greater than about 350 nm or even not greater than about 300 nm. It will be appreciated that the discontinuous silver-based functional film 630 may have an average thickness T_{FF} within a range between any of minimum and maximum values noted above. It will be further appreciated that the discontinuous silver-based functional film 630 may have an average thickness T_{FF} of any value between any of the minimum and maximum values noted above.

As noted herein, the discontinuous silver-based functional film 630 may include at least one silver-based functional layer. According to certain embodiments, the silver-based function layer of the discontinuous silver-based functional film 630 may have a particular thickness. For example, the silver-based function layer of the discontinuous silver-based functional film 630 may have an average thickness of at least about 4 nm, such as, at least about 5 nm or at least about 6 nm or at least about 7 nm or at least about 8 nm or at least about 9 nm or at least about 10 nm or at least about 11 nm or even at least about 12 nm. According to yet other embodiments, the silver-based function layer of the discontinuous silver-based functional film 630 may have an average thickness of not greater than about 20 nm or not greater than about 19 nm or not greater than about 18 nm or not greater than about 17 nm or not greater than about 16 nm or even not greater than about 15 nm. It will be appreciated that the silver-based function layer of the discontinuous silver-based functional film 630 may have an average thickness within a range between any of minimum and maximum values noted above. It will be further appreciated that the silver-based function layer of the discontinuous silver-based functional film 630 may have an average thickness of any value between any of the minimum and maximum values noted above.

According to still other embodiments, the discontinuous silver-based functional film 630 may have a particular functional film VLT. For example, the discontinuous silver-based functional film 630 may have a functional film VLT of at least about 1%, such as, at least about 5% or at least about 10% or at least about 15% or at least about 25% or at least about 30% or at least about 35% or at least about 40% or at least about 45% or at least about 50% or at least about 55% or at least about 60% or at least about 65% or at least about 70% or even at least about 75%. According to still other embodiments, the discontinuous silver-based functional film 630 may have a functional film VLT of not greater than about 99%. It will be appreciated that the discontinuous silver-based functional film 630 may have a functional film VLT within a range between any of minimum and maximum values noted above. It will be further appreciated that the discontinuous silver-based functional film 630 may have a functional film VLT of any value between any of the minimum and maximum values noted above.

According to still other embodiments, the discontinuous silver-based functional film 630 may have a particular functional film VLR. For example, the discontinuous silver-based functional film 630 may have a functional film VLR of at least about 1%, such as, at least about 3% or at least about 5% or even at least about 7%. According to still other embodiments, the discontinuous silver-based functional film 630 may have a functional film VLR of not greater than about 95%, such as, not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the discontinuous silver-based functional film 630 may have a functional film VLR within a range between any of minimum and maximum values noted above. It will be further appreciated that the discontinuous silver-based functional film 630 may have a functional film VLR of any value between any of the minimum and maximum values noted above.

According to still other embodiments, the discontinuous silver-based functional film 630 may have a particular functional film VLA. For example, the discontinuous silver-based functional film 630 may have a functional film VLA of at least about 1%, such as, at least about 3% or at least about 5% or even at least about 7%. According to still other embodiments, the discontinuous silver-based functional film 630 may have a functional film VLA of not greater than about 95%, such as, not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the discontinuous silver-based functional film 630 may have a functional film VLA within a range between any of minimum and maximum values noted above. It will be further appreciated that the discontinuous silver-based functional film 630 may have a functional film VLA of any value between any of the minimum and maximum values noted above.

According to still other embodiments, the discontinuous silver-based functional film 630 may have a particular functional film TE. For example, the discontinuous silver-based functional film 630 may have a functional film TE of at least about 2%, such as, at least about 5% or at least about 10% or at least about 25% or at least about 35% or even at least about 40%. According to still other embodiments, the discontinuous silver-based functional film 630 may have a functional film TE of not greater than about 80%, such as, not greater than about 70% or even not greater than about 60%. It will be appreciated that the discontinuous silver-based functional film 630 may have a functional film TE within a range between any of minimum and maximum values noted above. It will be further appreciated that the discontinuous silver-based functional film 630 may have a functional film TE of any value between any of the minimum and maximum values noted above.

According to still other embodiments, the discontinuous silver-based functional film 630 may have a particular functional film RE. For example, the discontinuous silver-based functional film 630 may have a functional film RE of at least about 10%, such as, at least about 15% or at least about 20%. According to still other embodiments, the discontinuous silver-based functional film 630 may have a functional film RE of not greater than about 70%, such as, not greater than about 60% or not greater than about 50% or not greater than about 40% or even not greater than about 30%. It will be appreciated that the discontinuous silver-based functional film 630 may have a functional film RE within a range between any of minimum and maximum values noted above. It will be further appreciated that the discontinuous silver-based functional film 630 may have a functional film RE of any value between any of the minimum and maximum values noted above.

According to still other embodiments, the discontinuous silver-based functional film 630 may have a particular functional film TTS. For example, the discontinuous silver-based functional film 630 may have a functional film TTS of at least about 10%, such as, at least about 25% or at least about 35% or even at least about 40%. According to still other embodiments, the discontinuous silver-based functional film 630 may have a functional film TTS of not greater than about 80%, such as, not greater than about 70% or even not greater than about 60%. It will be appreciated that the discontinuous silver-based functional film 630 may have a functional film TTS within a range between any of minimum and maximum values noted above. It will be further appreciated that the discontinuous silver-based functional film 630 may have a functional film TTS of any value between any of the minimum and maximum values noted above.

According to yet other embodiments, the over-layer 620 may have a particular thickness. For example, the over-layer 620 may have an average thickness of at least about 0.015 mm, such as, at least about 0.02 mm or at least about 0.025 mm or at least about 0.03 mm or at least about 0.035 mm or at least about 0.04 mm or at least about 0.045 mm or at least about 0.05 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to still other embodiments, the over-layer 620 may have an average thickness of not greater than about 3 mm, such as, not greater than about 2.5 mm or not greater than about 2.0 mm or not greater than about 1.5 mm or not greater than about 1.0 mm not greater than about 0.9 mm or even not greater than about 0.8 mm. It will be appreciated that the over-layer 620 may have an average thickness within a range between any of minimum and maximum values noted above. It will be further appreciated that the over-layer 620 may have an average thickness of any value between any of the minimum and maximum values noted above.

Referring back to FIG. 6, the over-layer 620 may have a first surface 622 that may contact the discontinuous silver-based functional film 630.

According to certain embodiments, the first surface 622 of the over-layer 620 may have a particular average surface roughness. For example, the first surface 622 of the over-layer 620 may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the first surface 622 of the over-layer 620 may have an average surface roughness of not greater than about 200 microns, such as, not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or even not greater than about 60 microns. It will be appreciated that the first surface 622 of the over-layer 620 may have an average surface roughness within a range between any of minimum and maximum values noted above. It will be further appreciated that the first surface 622 of the over-layer 620 may have an average surface roughness of any value between any of the minimum and maximum values noted above.

Referring back to FIG. 6, the over-layer 620 may have a second surface 624 that does not contact the discontinuous silver-based functional film 630. According to certain embodiments, the second surface 624 of the over-layer 620 may have a particular average surface roughness. For example, the second surface 624 of the over-layer 620 may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the second surface 624 of the over-layer 620 may have an average surface roughness of not greater than about 200 microns, such as, not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or even not greater than about 60 microns. It will be appreciated that the second surface 624 of the over-layer 620 may have an average surface roughness within a range between any of minimum and maximum values noted above. It will be further appreciated that the second surface 624 of the over-layer 620 may have an average surface roughness of any value between any of the minimum and maximum values noted above.

According to yet other embodiments, the under-layer 640 may have a particular thickness. For example, the under-layer 640 may have an average thickness of at least about 0.015 mm, such as, at least about 0.02 mm or at least about 0.025 mm or at least about 0.03 mm or at least about 0.035 mm or at least about 0.04 mm or at least about 0.045 mm or at least about 0.05 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to still other embodiments, the under-layer 640 may have an average thickness of not greater than about 3 mm, such as, not greater than about 2.5 mm or not greater than about 2.0 mm or not greater than about 1.5 mm or not greater than about 1.0 mm not greater than about 0.9 mm or even not greater than about 0.8 mm. It will be appreciated that the under-layer 640 may have an average thickness within a range between any of minimum and maximum values noted above. It will be further appreciated that the under-layer 640 may have an average thickness of any value between any of the minimum and maximum values noted above.

Referring back to FIG. 6, the under-layer 640 may have a first surface 642 that may contact the discontinuous silver-based functional film 630. According to certain embodiments, the first surface 642 of the under-layer 640 may have a particular average surface roughness. For example, the first surface 642 of the under-layer 640 may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the first surface 642 of the under-layer 640 may have an average surface roughness of not greater than about 100 microns, such as, not greater than about 90 microns or not greater than about 80 microns or not greater than about 70 microns or even not greater than about 60 microns. It will be appreciated that the first surface 642 of the under-layer 640 may have an average surface roughness within a range between any of minimum and maximum values noted above. It will be further appreciated that the first surface 642 of the under-layer 640 may have an average surface roughness of any value between any of the minimum and maximum values noted above.

Referring back to FIG. 6, the under-layer 640 may have a second surface 644 that does not contact the discontinuous silver-based functional film 630. According to certain embodiments, the second surface 644 of the under-layer 640 may have a particular average surface roughness. For example, the second surface 644 of the under-layer 640 may have an average surface roughness of at least about at least about 1 micron, such as, at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or even at least about 45 microns. According to yet other embodiments, the second surface 644 of the under-layer 640 may have an average surface roughness of not greater than about 100 microns, such as, not greater than about 90 microns or not greater than about 80 microns or not greater than about 70 microns or even not greater than about 60 microns. It will be appreciated that the second surface 644 of the under-layer 640 may have an average surface roughness within a range between any of minimum and maximum values noted above. It will be further appreciated that the second surface 644 of the under-layer 640 may have an average surface roughness of any value between any of the minimum and maximum values noted above.

According to still other embodiments, the composite film 600 may have a particular thickness. For example, the composite film 600 may have an average thickness of at least about 0.03 mm, such as, at least about 0.04 mm or at least about 0.05 mm or at least about 0.06 mm or at least about 0.07 mm or at least about 0.08 mm or at least about 0.09 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or even at least about 0.5 mm. According to yet other embodiments, the composite film 600 may have an average thickness of not greater than about 2 mm or not greater than about 1.5 mm or not greater than about 1 mm. It will be appreciated that the composite film 600 may have an average thickness within a range between any of minimum and maximum values noted above. It will be further appreciated that the composite film 600 may have an average thickness of any value between any of the minimum and maximum values noted above.

According to yet other embodiments, the composite film 600 may have a particular R/sq value. For example, the composite film 600 may have an R/sq value or at least about 30 Ohm/sq, such as, at least about 40 Ohm/sq or at least about 50 Ohm/sq or at least about 60 Ohm/sq or at least about 70 Ohm/sq or at least about 80 Ohm/sq or at least about 90 Ohm/sq or at least about 100 Ohm/sq or at least about 110 Ohm/sq or at least about 120 Ohm/sq or at least about 130 Ohm/sq or at least about 140 Ohm/sq or at least about 150 Ohm/sq or at least about 160 Ohm/sq or at least about 170 Ohm/sq or at least about 180 Ohm/sq or at least about 190 Ohm/sq or at least about 200 Ohm/sq or at least about 210 Ohm/sq or at least about 620 Ohm/sq or at least about 630 Ohm/sq or at least about 640 Ohm/sq or even at least about 250 Ohm/sq. It will be appreciated that the composite film 600 may have an R/sq value between any of values noted above. It will be further appreciated that the composite film 600 may have an R/sq value of any value between any of the values noted above.

Alternative embodiments described herein are generally directed to laminate of a composite film and methods of forming the laminate. According to particular embodiments, such a laminate may be formed by laminating a composite film 600 formed according to embodiments described herein, between a first substrate and a second substrate. According to particular embodiments described herein, such laminates may have particular performance characteristics, such as, high visible light transmittance, low TTS and high RF transparency (i.e., a high R/sq value).

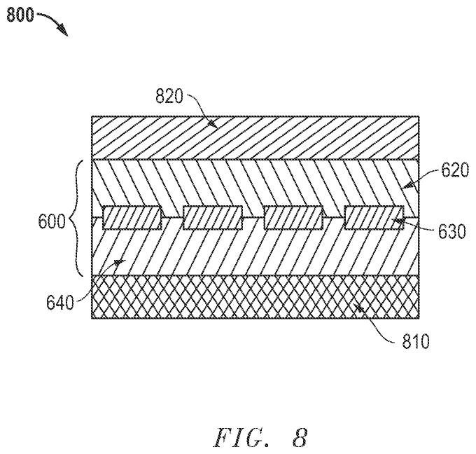

For purposes of illustrate, FIG. 8 includes an illustration of a cross-sectional view of a portion of an embodiment of a laminate 800 formed according to embodiments described herein. As shown in FIG. 8, a laminate 800 may include a first substrate 810, a second substrate 820 and a composite film 600 between the first substrate 810 and the second substrate 810. As shown in FIG. 8, the composite film 600 may include an under-layer 640, a discontinuous silver-based functional film 630 overlying the under-layer 640, and an over-layer 620 overlying the discontinuous silver-based functional film 620. The under-layer 640 may include TPU and the over-layer 620 may include TPU. Described another way and as also shown in FIG. 8, a laminate 800 may include a first substrate 810, a under-layer 640 overlying the first substrate 810, a discontinuous silver-based functional film 630 overlying the under-layer 640, an over-layer 620 overlying the discontinuous silver-based functional film 630, and a second substrate 820 overlying the over-layer 620.

According to particular embodiments, the first substrate 810 may include a polymer material. According to another particular embodiment, the first substrate 810 may consist of a polymer material. According to still other embodiments, the first substrate 810 may be a polymer substrate layer. According to particular embodiments, the polymer substrate layer may include any desirable polymer material.

According to still other embodiments, the first substrate 810 may include a polyethylene terephthalate (PET) material. According to another particular embodiment, the first substrate 810 may consist of a PET material. According to still other embodiments, the first substrate 810 may be a PET substrate layer. According to particular embodiments, the PET substrate layer may include any desirable polymer material.

According to yet another embodiment, the first substrate 810 may include a glass material. According to yet another embodiment, the first substrate 810 may consist of a glass material. According to still another embodiment, the first substrate 810 may be a glass substrate layer. According to still other embodiments, the glass material may include any desirable glass material.

It will be further appreciated that when the first substrate 810 is a glass substrate layer.

According to certain embodiments, the first substrate 810 may have a particular thickness. For example, the first substrate 810 may have an average thickness of at least about 0.2 mm, such as, at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.5 mm or at least about 2.0 mm or even at least about 2.5 mm. According to still other embodiments, the first substrate 810 may have an average thickness of not greater than about 19 mm, such as, not greater than about 18 mm or not greater than about 17 mm or not greater than about 16 mm or not greater than about 15 mm or not greater than about 14 mm or not greater than about 13 mm or not greater than about 12 mm or not greater than about 11 mm or not greater than about 10 mm or not greater than about 9 mm or not greater than about 8 mm or not greater than about 7 mm or not greater than about 6 mm or not greater than about 5 mm or not greater than about 4 mm or not greater than about 3.75 mm or not greater than about 3.5 mm or not greater than about 3.25 mm or not greater than about 3.0 mm. It will be appreciated that the first substrate 810 may have an average thickness within a range between any of minimum and maximum values noted above. It will be further appreciated that the first substrate 810 may have an average thickness of any value between any of the minimum and maximum values noted above.

According to particular embodiments, the second substrate 820 may include a polymer material. According to another particular embodiment, the second substrate 820 may consist of a polymer material. According to still other embodiments, the second substrate 820 may be a polymer substrate layer. According to particular embodiments, the polymer substrate layer may include any desirable polymer material.

According to still other embodiments, the second substrate 820 may include a polyethylene terephthalate (PET) material. According to another particular embodiment, the second substrate 820 may consist of a PET material. According to still other embodiments, the second substrate 820 may be a PET substrate layer. According to particular embodiments, the PET substrate layer may include any desirable polymer material.

According to yet another embodiment, the second substrate 820 may include a glass material. According to yet another embodiment, the second substrate 820 may consist of a glass material. According to still another embodiment, the second substrate 820 may be a glass substrate layer. According to still other embodiments, the glass material may include any desirable glass material.

It will be further appreciated that when the second substrate 820 is a glass substrate layer.

According to certain embodiments, the second substrate 820 may have a particular thickness. For example, the second substrate 820 may have an average thickness of at least about 0.2 mm, such as, or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.5 mm or at least about 2.0 mm or even at least about 2.5 mm. According to still other embodiments, the second substrate 820 may have an average thickness of not greater than about 19 mm, such as, not greater than about 18 mm or not greater than about 17 mm or not greater than about 16 mm or not greater than about 15 mm or not greater than about 14 mm or not greater than about 13 mm or not greater than about 12 mm or not greater than about 11 mm or not greater than about 10 mm or not greater than about 9 mm or not greater than about 8 mm or not greater than about 7 mm or not greater than about 6 mm or not greater than about 5 mm or not greater than about 4 mm or not greater than about 3.75 mm or not greater than about 3.5 mm or not greater than about 3.25 mm or not greater than about 3.0 mm. It will be appreciated that the second substrate 820 may have an average thickness within a range between any of minimum and maximum values noted above. It will be further appreciated that the second substrate 820 may have an average thickness of any value between any of the minimum and maximum values noted above.

According to still other embodiments, the laminate 800 may have a particular thickness. For example, the laminate 800 may have an average thickness of at least about 1.0 mm, such as, at least about 2.0 mm or even at least about 3.0 mm. According to still other embodiment, the laminate 800 may have an average thickness of not greater than about 38 mm, such as, not greater than about 37 mm or not greater than about 36 mm or not greater than about 35 mm or not greater than about 34 mm or not greater than about 33 mm or not greater than about 32 mm or not greater than about 31 mm or not greater than about 30 mm or not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 20 mm or not greater than about 19 mm or not greater than about 18 mm or not greater than about 17 mm or not greater than about 16 mm or not greater than about 15 mm or not greater than about 14 mm or not greater than about 13 mm or not greater than about 12 mm or not greater than about 11 mm or not greater than about 10 mm or not greater than about 9 mm or not greater than about 8 mm or not greater than about 7 mm or not greater than about 6 mm. It will be appreciated that the laminate 800 may have an average thickness within a range between any of minimum and maximum values noted above. It will be further appreciated that the laminate 800 may have an average thickness of any value between any of the minimum and maximum values noted above.

According to yet other embodiments, the laminate 800 may have a particular R/sq value. For example, the laminate 800 may have an R/sq value or at least about 30 Ohm/sq, such as, at least about 40 Ohm/sq or at least about 50 Ohm/sq or at least about 60 Ohm/sq or at least about 70 Ohm/sq or at least about 80 Ohm/sq or at least about 90 Ohm/sq or at least about 100 Ohm/sq or at least about 110 Ohm/sq or at least about 120 Ohm/sq or at least about 130 Ohm/sq or at least about 140 Ohm/sq or at least about 150 Ohm/sq or at least about 160 Ohm/sq or at least about 170 Ohm/sq or at least about 180 Ohm/sq or at least about 190 Ohm/sq or at least about 200 Ohm/sq or at least about 210 Ohm/sq or at least about 620 Ohm/sq or at least about 630 Ohm/sq or at least about 640 Ohm/sq or even at least about 250 Ohm/sq. It will be appreciated that the laminate 800 may have an R/sq value between any of values noted above. It will be further appreciated that the laminate 800 may have an R/sq value of any value between any of the values noted above.

According to still other embodiments, the laminate 800 may have a particular laminate VLT. It will be appreciated that the laminate VLT may be dependent on the clarity of the outer layers in the laminate (i.e., the clarity of the TPU layer or the glazings). For example, where the laminate 800 includes clear TPU layers (and other glazings), the laminate 800 may have a laminate VLT of at least about 1%, such as, at least about 5% or at least about 10% or at least about 15% or at least about 20% or at least about 25% or at least about 30% or at least about 35% or at least about 40% or at least about 45% or at least about 50% or at least about 55% or at least about 60% or at least about 65% or at least about 70% or even at least about 75%. According to still other embodiments, the laminate 800 may have a laminate VLT of not greater than about 99%. It will be appreciated that the laminate 800 may have a laminate VLT within a range between any of minimum and maximum values noted above. It will be further appreciated that the laminate 800 may have a laminate VLT of any value between any of the minimum and maximum values noted above.

It will further be appreciated that the composite film 600 may be used in a laminate with non-clear materials (i.e., dark substrate or TPU layers). In such applications, the laminate VLT may be low, for example, not greater than about 30%, such as, not greater than about 25% or not greater than about 20% or not greater than about 15% or not greater than about 10% or not greater than about 9% or not greater than about 8% or not greater than about 7% or not greater than about 6% or even not greater than about 5%.

According to still other embodiments, the laminate 800 may have a particular laminate VLR. For example, the laminate 800 may have a laminate VLR of at least about 1%, such as, at least about 3% or at least about 5% or even at least about 7%. According to still other embodiments, the laminate 800 may have a laminate VLR of not greater than about 99%, such as, not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the laminate 800 may have a laminate VLR within a range between any of minimum and maximum values noted above. It will be further appreciated that the laminate 800 may have a laminate VLR of any value between any of the minimum and maximum values noted above.

According to still other embodiments, the laminate 800 may have a particular laminate VLA. For example, the laminate 800 may have a laminate VLA of at least about 1%, such as, at least about 3% or at least about 5% or even at least about 7%. According to still other embodiments, the laminate 800 may have a laminate VLA of not greater than about 95%, such as, not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or even not greater than about 15%. It will be appreciated that the laminate 800 may have a laminate VLA within a range between any of minimum and maximum values noted above. It will be further appreciated that the laminate 800 may have a laminate VLA of any value between any of the minimum and maximum values noted above.

According to still other embodiments, the laminate 800 may have a particular laminate TE. For example, the laminate 800 may have a laminate TE of at least about 2%, such as, at least about 2% or at least about 5% or at least about 10% or at least about 25% or at least about 35% or even at least about 40%. According to still other embodiments, the laminate 400 may have a laminate TE of not greater than about 80%, such as, not greater than about 70% or even not greater than about 60%. It will be appreciated that the laminate 800 may have a laminate TE within a range between any of minimum and maximum values noted above. It will be further appreciated that the laminate 800 may have a laminate TE of any value between any of the minimum and maximum values noted above.

According to still other embodiments, the laminate 800 may have a particular laminate RE. For example, the laminate 800 may have a laminate RE of at least about 10%, such as, at least about 15% or at least about 20%. According to still other embodiments, the laminate 800 may have a laminate RE of not greater than about 70%, such as, not greater than about 60% or not greater than about 50% or not greater than about 40% or even not greater than about 30%. It will be appreciated that the laminate 800 may have a laminate RE within a range between any of minimum and maximum values noted above. It will be further appreciated that the laminate 800 may have a laminate RE of any value between any of the minimum and maximum values noted above.

According to still other embodiments, the laminate 800 may have a particular laminate TTS. For example, the laminate 800 may have a laminate TTS of at least about 10%, such as, at least about 25% or at least about 35% or even at least about 40%. According to still other embodiments, the laminate 800 may have a laminate TTS of not greater than about 80%, such as, not greater than about 70% or even not greater than about 60%. It will be appreciated that the laminate 800 may have a laminate TTS within a range between any of minimum and maximum values noted above. It will be further appreciated that the laminate 800 may have a laminate TTS of any value between any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A composite film comprising: a discontinuous silver-based functional film; and an over-layer comprising TPU and overlying the discontinuous silver-based functional film, wherein the composite film comprises an R/sq value of at least about 30 Ohm/sq.

Embodiment 2. A laminate comprising: a first substrate; a discontinuous silver-based functional film overlying the first substrate; an over-layer comprising TPU and overlying the discontinuous silver-based functional film, and a second substrate overlying the over-layer, wherein the laminate comprises an R/sq value of at least about 30 Ohm/sq.

Embodiment 3. A method of forming a composite film comprising: providing a silver-based functional film attached to a first surface of a sacrificial film; conducting a first lamination of an over-layer onto a second surface of the silver-based functional film, wherein the over-layer comprises TPU, and wherein the silver-based functional film is between the over-layer and the sacrificial film; and conducting a delamination of the silver-based functional film from the sacrificial film to form a discontinuous silver-based functional film attached to the over-layer to form a composite film.

Embodiment 4. A composite film comprising: an under-layer comprising TPU; a discontinuous silver-based functional film overlying the under-layer; and an over-layer comprising TPU and overlying the discontinuous silver-based functional film, wherein the composite film comprises an R/sq value of at least about 30 Ohm/sq.

Embodiment 5. A laminate comprising: a first substrate; an under-layer comprising TPU and overlying the first substrate; a discontinuous silver-based functional film overlying the under-layer; an over-layer comprising TPU and overlying the discontinuous silver-based functional film, and a second substrate overlying the over-layer, wherein the laminate comprises an R/sq value of at least about 30 Ohm/sq.

Embodiment 6. A method of forming a composite film comprising: providing a silver-based functional film attached to a first surface of a sacrificial film; conducting a first lamination of an over-layer onto a second surface of the silver-based functional film, wherein the over-layer comprises TPU, and wherein the silver-based functional film is between the over-layer and the sacrificial film; conducting a delamination of the silver-based functional film from the sacrificial film to form a discontinuous silver-based functional film attached to the over-layer; and conducting a second lamination of the discontinuous silver-based functional film attached to the over-layer onto an under-layer to form a composite film, wherein the under-layer comprises TPU and wherein the discontinuous silver-based functional film is between the over-layer and the under-layer.

Embodiment 7. The composite film, laminate or method of any one of embodiments 1, 2, 3, 4, 5, and 6, wherein the discontinuous silver-based functional film comprises at least one discontinuity over a length of 1 cm of the functional film or at least about two discontinuities over a length of 1 cm of the functional film or at least about three discontinuities over a length of 1 cm of the functional film or at least about 4 discontinuities over a length of 1 cm of the functional film.

Embodiment 8. The composite film, laminate or method of embodiment 7, wherein the discontinuities of the discontinuous silver-based functional film have an average gap length of at least about 0.1 microns or at least about 0.2 microns or at least about 0.3 microns or at least about 0.4 microns or at least about 0.5 microns or at least about 0.6 microns or at least about 0.7 microns or at least about 0.8 microns or at least about 0.9 microns or at least about 1 microns or at least about 2 microns or at least about 3 microns or at least about 4 microns or at least about 5 microns or at least about 6 microns or at least about 7 microns or at least about 8 microns or at least about 9 microns or at least about 10 microns or at least about 10 microns or at least about 11 microns or at least about 12 microns or at least about 13 microns or at least about 14 microns or at least about 15 microns or at least about 16 microns or at least about 17 microns or at least about 18 microns or at least about 19 microns or at least about 20 microns or at least about 25 microns or at least about 30 microns or at least about 35 microns or at least about 40 microns or at least about 50 microns.

Embodiment 9. The composite film, laminate or method of embodiment 8, wherein the discontinuities of the discontinuous silver-based functional film have an average gap length of not greater than about 100 microns or not greater than about 90 microns or not greater than about 80 microns or not greater than about 70 microns or not greater than about 60 microns.

Embodiment 10. The composite film, laminate or method of any one of embodiments 1, 2, 3, 4, 5, and 6, wherein the discontinuous silver-based functional film comprises an irregular distribution of discontinuities.

Embodiment 11. The composite film, laminate or method of any one of embodiments 1, 2, 3, 4, 5, and 6, wherein the discontinuous silver-based functional film comprises a regular distribution of discontinuities.

Embodiment 12. The composite film, laminate or method of any one of embodiments 1, 2, 3, 4, 5, and 6, wherein the discontinuous silver-based functional film comprises an average thickness of at least about 5 nm or at least about 10 nm or at least about 15 nm or at least about 20 nm or at least about 25 nm or at least about 30 nm or at least about 35 nm or at least about 40 nm or at least about 45 nm or at least about 50 nm or at least about 75 nm or at least about 100 nm or at least about 125 nm or at least about 150 nm or at least about 175 nm or at least about 200 nm or at least about 225 nm or at least about 250 nm.

Embodiment 13. The composite film, laminate or method of any one of embodiments 1, 2, 3, 4, 5, and 6, wherein the discontinuous silver-based functional film comprises an average thickness of not greater than about 500 nm or not greater than about 450 nm or not greater than about 400 nm or not greater than about 350 nm or not greater than about 300 nm.

Embodiment 14. The composite film, laminate or method of any one of embodiments 1, 2, 3, 4, 5, and 6, wherein the discontinuous silver-based functional film comprises a silver-based functional layer, wherein the discontinuous silver-based function film comprises at least 2 silver-based functional layers, wherein the discontinuous silver-based function film comprises at least comprises at least 3 functional layers.

Embodiment 15. The composite film, laminate or method of embodiment 14, wherein the discontinuous silver-based functional layer comprises an average thickness of at least about 4 nm or at least about 5 nm or at least about 6 nm or at least about 7 nm or at least about 8 nm or at least about 9 nm or at least about 10 nm or at least about 11 nm or at least about 12 nm.

Embodiment 16. The composite film, laminate or method of embodiment 15, wherein the discontinuous silver-based functional layer comprises an average thickness of not greater than about 20 nm or not greater than about 19 nm or not greater than about 18 nm or not greater than about 17 nm or not greater than about 16 nm or not greater than about 15 nm.

Embodiment 17. The composite film, laminate or method of any one of embodiments 1, 2, 3, 4, 5, and 6, wherein the over-layer comprises an average thickness of at least about 0.015 mm or at least about 0.02 mm or at least about 0.025 mm or at least about 0.03 mm or at least about 0.035 mm or at least about 0.04 mm or at least about 0.045 mm or at least about 0.05 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or at least about 0.5 mm.

Embodiment 18. The composite film, laminate or method of embodiment 17, wherein the over-layer comprises an average thickness of not greater than about 3 mm or not greater than about 2.5 mm or not greater than about 2.0 mm or not greater than about 1.5 mm or not greater than about 1 mm or not greater than about 0.9 mm or not greater than about 0.8 mm.

Embodiment 19. The composite film, laminate or method of any one of embodiments 1, 2, 3, 4, 5, and 6, wherein the over-layer comprises a first surface in contact with the discontinuous silver-based functional layer and wherein the first surface of the over-layer comprises an average surface roughness of at least about at least about 1 micron or at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or at least about 45 microns.

Embodiment 20. The composite film, laminate or method of embodiment 19, wherein the first surface of the over-layer comprises an average surface roughness of not greater than about 200 microns or not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or not greater than about 60 microns.

Embodiment 21. The composite film, laminate or method of any one of embodiments 1, 2, 3, 4, 5, and 6, wherein the over-layer comprises a second surface not in contact with the discontinuous silver-based functional layer and wherein the second surface of the over-layer comprises an average surface roughness of at least about at least about 1 micron or at least about 2 microns or at least about 3 microns or at least about 4 microns or at least about 5 microns or at least about 10 microns or at least about 15 microns or at least about 20 microns or at least about 25 microns or at least about 30 microns or at least about 35 microns or at least about 40 microns or at least about 45 microns.

Embodiment 22. The composite film, laminate or method of embodiment 21, wherein the second surface of the over-layer comprises an average surface roughness of not greater than about 200 microns or not greater than about 190 microns or not greater than about 180 microns or not greater than about 170 microns or not greater than about 160 microns or not greater than about 150 microns or not greater than about 140 microns or not greater than about 130 microns or not greater than about 120 microns or not greater than about 110 microns or not greater than about 100 microns or not greater than about 90 microns or not greater than about 80 microns or not greater than about 70 microns or not greater than about 60 microns.

Embodiment 23. The composite film, laminate or method of any one of embodiments 1, 2, 3, 4, 5, and 6, wherein the composite film comprises an average thickness of at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.15 mm or at least about 0.2 mm or at least about 0.25 mm or at least about 0.3 mm or at least about 0.35 mm or at least about 0.4 mm or at least about 0.45 mm or at least about 0.5 mm.

Embodiment 24. The composite film of embodiment 23, wherein the composite film comprises an average thickness of not greater than about 2 mm or not greater than about 1.5 mm or not greater than about 1 mm.

Embodiment 25. The composite film, laminate or method of any one of embodiments 1, 2, 3, 4, 5, and 6, wherein the composite film comprises an R/sq value or at least about 10 Ohm/sq or at least about 20 Ohm/sq or at least about 30 Ohm/sq or at least about 40 Ohm/sq or at least about 50 Ohm/sq or at least about 60 Ohm/sq or at least about 70 Ohm/sq or at least about 80 Ohm/sq or at least about 90 Ohm/sq or at least about 100 Ohm/sq or at least about 110 Ohm/sq or at least about 120 Ohm/sq or at least about 130 Ohm/sq or at least about 140 Ohm/sq or at least about 150 Ohm/sq or at least about 160 Ohm/sq or at least about 170 Ohm/sq or at least about 180 Ohm/sq or at least about 190 Ohm/sq or at least about 200 Ohm/sq or at least about 210 Ohm/sq or at least about 620 Ohm/sq or at least about 230 Ohm/sq or at least about 240 Ohm/sq or at least about 250 Ohm/sq.

Embodiment 26. The composite film, laminate or method of any one of embodiments 1, 2, 3, 4, 5, and 6, wherein the discontinuous silver-based functional film comprises a functional film VLT of at least about 1% or at least about 5% or at least about 10% or at least about 15% or at least about 20% or at least about 25% or at least about 30% or at least about 35% or at least about 40% or at least about 45% or at least about 50% or at least about 55% or at least about 60% or at least about 65% or at least about 70% or at least about 75%.

Embodiment 27. The composite film of embodiment 26, wherein the discontinuous silver-based functional film comprises a functional film VLT of not greater than about 99%.

Embodiment 28. The composite film, laminate or method of any one of embodiments 1, 2, 3, 4, 5, and 6, wherein the discontinuous silver-based functional film comprises a functional film VLR of at least about 1% or at least about 3% or at least about 5% or at least about 7%.

Embodiment 29. The composite film of embodiment 28, wherein the discontinuous silver-based functional film comprises a functional film VLR of not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or not greater than about 15%.

Embodiment 30. The composite film, laminate or method of any one of embodiments 1, 2, 3, 4, 5, and 6, wherein the discontinuous silver-based functional film comprises a functional film VLA of at least about 1% or at least about 3% at least about 5% or at least about 7%.

Embodiment 31. The composite film of embodiment 30, wherein the discontinuous silver-based functional film comprises a functional film VLA of not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or not greater than about 15%.

Embodiment 32. The composite film, laminate or method of any one of embodiments 1, 2, 3, 4, 5, and 6, wherein the discontinuous silver-based functional film comprises a functional film TE of at least about 2% or at least about 5% or at least about 10% or at least about 25% or at least about 40%.

Embodiment 33. The composite film of embodiment 32, wherein the discontinuous silver-based functional film comprises a functional film TE of not greater than about 80% or not greater than about 70% or not greater than about 60%.

Embodiment 34. The composite film, laminate or method of any one of embodiments 1, 2, 3, 4, 5, and 6, wherein the discontinuous silver-based functional film comprises a functional film RE of at least about 10% or at least about 15% or at least about 20%.

Embodiment 35. The composite film of embodiment 34, wherein the discontinuous silver-based functional film comprises a functional film RE of not greater than about 70% or not greater than about 60% or not greater than about 50% or not greater than about 40% or not greater than about 30%.

Embodiment 36. The composite film, laminate or method of any one of embodiments 1, 2, 3, 4, 5, and 6, wherein the discontinuous silver-based functional film comprises a functional film TTS of at least about 10% or at least about 25% or at least about 40%.

Embodiment 37. The composite film of embodiment 36, wherein the discontinuous silver-based functional film comprises a functional film TTS of not greater than about 80% or not greater than about 70% or not greater than about 60%.

Embodiment 38. The laminate or method of any one of embodiments 2, 3, 5, and 6, wherein the first substrate is a glass substrate.

Embodiment 39. The laminate or method of any one of embodiments 2, 3, 5, and 6, wherein the first substrate comprises an average thickness of at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.5 mm or at least about 2.0 mm or at least about 2.5 mm.

Embodiment 40. The laminate of embodiment 39, wherein the first substrate comprises an average thickness of not greater than about 19 mm or not greater than about 18 mm or not greater than about 17 mm or not greater than about 16 mm or not greater than about 15 mm or not greater than about 14 mm or not greater than about 13 mm or not greater than about 12 mm or not greater than about 11 mm or not greater than about 10 mm or not greater than about 9 mm or not greater than about 8 mm or not greater than about 7 mm or not greater than about 6 mm or not greater than about 5 mm or not greater than about 4 mm or not greater than about 3.75 mm or not greater than about 3.5 mm or not greater than about 3.25 mm or not greater than about 3.0 mm.

Embodiment 41. The laminate or method of any one of embodiments 2, 3, 5, and 6, wherein the second substrate is a glass substrate, wherein the second substrate is a polycarbonate substrate.

Embodiment 42. The laminate or method of any one of embodiments 2, 3, 5, and 6, wherein the second substrate comprises an average thickness of at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.5 mm or at least about 2.0 mm or at least about 2.5 mm.

Embodiment 43. The laminate of embodiment 42, wherein the second substrate comprises an average thickness of not greater than about 19 mm or not greater than about 18 mm or not greater than about 17 mm or not greater than about 16 mm or not greater than about 15 mm or not greater than about 14 mm or not greater than about 13 mm or not greater than about 12 mm or not greater than about 11 mm or not greater than about 10 mm or not greater than about 9 mm or not greater than about 8 mm or not greater than about 7 mm or not greater than about 6 mm or not greater than about 5 mm or not greater than about 4 mm or not greater than about 3.75 mm or not greater than about 3.5 mm or not greater than about 3.25 mm or not greater than about 3.0 mm.

Embodiment 44. The laminate or method of any one of embodiments 2, 3, 5, and 6, wherein the laminate comprises an average thickness of at least about 1.0 mm or at least about 2.0 mm or at least about 3.0 mm.

Embodiment 45. The laminate of embodiment 44, wherein the laminate comprises an average thickness of not greater than about 38 mm or not greater than about 37 mm or not greater than about 36 mm or not greater than about 35 mm or not greater than about 34 mm or not greater than about 33 mm or not greater than about 32 mm or not greater than about 31 mm or not greater than about 30 mm or not greater than about 29 mm or not greater than about 28 mm or not greater than about 27 mm or not greater than about 26 mm or not greater than about 25 mm or not greater than about 24 mm or not greater than about 23 mm or not greater than about 22 mm or not greater than about 20 mm or not greater than about 19 mm or not greater than about 18 mm or not greater than about 17 mm or not greater than about 16 mm or not greater than about 15 mm or not greater than about 14 mm or not greater than about 13 mm or not greater than about 12 mm or not greater than about 11 mm or not greater than about 10 mm or not greater than about 9 mm or not greater than about 8 mm or not greater than about 7 mm or not greater than about 6 mm.

Embodiment 46. The laminate or method of any one of embodiments 2, 3, 5, and 6, wherein the laminate comprises an R/sq value of at least about 10 Ohm/sq or at least about 20 Ohm/sq or at least about 30 Ohm/sq or at least about 40 Ohm/sq or at least about 50 Ohm/sq of at least about 60 Ohm/sq of at least about 70 Ohm/sq of at least about 80 Ohm/sq of at least about 90 Ohm/sq of at least about 100 Ohm/sq of at least about 110 Ohm/sq of at least about 120 Ohm/sq of at least about 130 Ohm/sq of at least about 140 Ohm/sq of at least about 150 Ohm/sq of at least about 160 Ohm/sq of at least about 170 Ohm/sq of at least about 180 Ohm/sq of at least about 190 Ohm/sq of at least about 200 Ohm/sq of at least about 210 Ohm/sq of at least about 620 Ohm/sq of at least about 230 Ohm/sq of at least about 240 Ohm/sq of at least about 250 Ohm/sq.

Embodiment 47. The laminate or method of any one of embodiments 2, 3, 5, and 6, wherein the laminate comprises a laminate VLT of at least about 1% or at least about 5% or at least about 10% or at least about 15% or at least about 20% or at least about 25% or at least about 30% or at least about 35% or at least about 40% or at least about 45% or at least about 50% or at least about 55% or at least about 60% or at least about 65% or at least about 70% or at least about 75%.

Embodiment 48. The laminate of embodiment 47, wherein the laminate comprises a laminate VLT of not greater than about 99%.

Embodiment 49. The laminate or method of any one of embodiments 2, 3, 5, and 6, wherein the laminate comprises a laminate haze value of not greater than about 10% or not greater than about 5% or not greater than about 2%.

Embodiment 50. The laminate or method of any one of embodiments 2, 3, 5, and 6, wherein the laminate comprises a laminate VLR of at least about 1% or at least about 5% or at least about 7%.

Embodiment 51. The laminate of embodiment 50, wherein the laminate comprises a laminate VLR of not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or not greater than about 15%.

Embodiment 52. The laminate or method of any one of embodiments 2, 3, 5, and 6, wherein the laminate comprises a laminate VLA of at least about 1% or at least about 5% or at least about 7%.

Embodiment 53. The laminate of embodiment 52, wherein the laminate comprises a laminate VLA of not greater than about 95% or not greater than about 90% or not greater than about 85% or not greater than about 80% or not greater than about 75% or not greater than about 70% or not greater than about 65% or not greater than about 60% or not greater than about 55% or not greater than about 50% or not greater than about 45% or not greater than about 40% or not greater than about 35% or not greater than about 30% or not greater than about 25% or not greater than about 20% or not greater than about 15%.

Embodiment 54. The laminate or method of any one of embodiments 2, 3, 5, and 6, wherein the laminate comprises a laminate TE of at least about 2% or at least about 5% or at least about 10% or at least about 25% or at least about 40%.

Embodiment 55. The laminate or method of any one of embodiments 2, 3, 5, and 6, wherein the laminate comprises a laminate TE of not greater than about 80% or not greater than about 70% or not greater than about 60%.

Embodiment 56. The laminate or method of any one of embodiments 2, 3, 5, and 6, wherein the laminate comprises a laminate RE of at least about 10% or at least about 15% or at least about 20%.

Embodiment 57. The laminate of embodiment 56, wherein the laminate comprises a laminate RE of not greater than about 70% or not greater than about 60% or not greater than about 50% or not greater than about 40% or not greater than about 30%.

Embodiment 58. The laminate or method of any one of embodiments 2, 3, 5, and 6, wherein the laminate comprises a laminate TTS of at least about 10% or at least about 25% or at least about 40%.

Embodiment 59. The laminate of embodiment 58, wherein the laminate comprises a laminate TTS of not greater than about 80% or not greater than about 70% or not greater than about 60%.

### EXAMPLES

The concepts described herein will be further described in the following Examples, which do not limit the scope of the invention described in the claims.

### Example 1

A sample laminate of composite film S1 was configured and formed according to certain embodiments described herein. Sample S1 includes a first glass substrate (i.e., bottom), an under-layer that includes TPU overlying a surface of the bottom glass substrate, a discontinuous silver-based functional film overlying the under-layer, an over-layer that includes TPU overlying the discontinuous silver-based functional film, and a second glass substrate (i.e., top) overlying the over-layer. The discontinuous silver-based functional film has the following layer configuration: TiOx (25 nm)/Ag (10 nm)/TiOx (60 nm)/Ag (10 nm)/TiOx (20 nm). It will be appreciated that the order of the layers listed for the discontinuous silver-based functional film indicates the order of the layers with the first layer listed corresponds to the top layer in the composite film.

The sample S1 was formed according to embodiments described herein. Specifically, a PET film coated with the functional silver-based film was prelaminated with a 0.38 mm TPU layer. Prelamination was carried out by superimposing the coated PET film and the TPU layer in a vacuum created using standard vacuum sealing machine. The prelamination included 1 hour of heating in an oven at a temperature 90° C. After cooling down and opening of the vacuum pouch, delamination of the PET film from the TPU layer is carried out manually. Lamination with glass and a second 0.38 mm TPU was then carried out using an autoclave process at a temperature of 140° C. under a pressure of 10 bars.

Optical properties of the sample laminate S1 are summarized in Table 1 below. The summarized optical properties include: laminate VLT, laminate VLR, laminate TE, laminate RE, laminate TTS, HAZE, R/Sq. All optical properties were measured according to ISO 9050 using a Perkin Elmer Lambda 900 spectrophotometer.

TABLE 1
Sample Laminate Optical Property Measurements

| OPTICAL PROPERTIES | S1 |
|---|---|
| VLT (%) | 75.9 |
| VLR (%) | 8.3 |
| VLA (%) | |
| TE (%) | 50.8 |
| RE (%) | 22.0 |
| TTS (%) | 58.3 |
| HAZE (%) | 1.0 |
| R/Sq | >5000 |
| (Ohm/sq) | |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A composite film comprising:
a discontinuous silver-based functional film; and
an over-layer comprising TPU and overlying the discontinuous silver-based functional film,
wherein the composite film comprises an R/sq value of at least about 30 Ohm/sq.

2. The composite film of claim 1, wherein the discontinuous silver-based functional film comprises at least one discontinuity over a length of 1 cm of the functional film.

3. The composite film of claim 2, wherein the discontinuities of the discontinuous silver-based functional film have an average gap length of at least about 0.1 microns and not greater than about 100 microns.

4. The composite film of claim 1, wherein the discontinuous silver-based functional film comprises an irregular distribution of discontinuities.

5. The composite film of claim 1, wherein the discontinuous silver-based functional film comprises a regular distribution of discontinuities.

6. The composite film of claim 1, wherein the discontinuous silver-based functional film comprises an average thickness of at least about 5 and not greater than about 500 nm.

7. The composite film of claim 1, wherein the discontinuous silver-based functional film comprises a silver-based functional layer.

8. The composite film of claim 7, wherein the discontinuous silver-based functional layer comprises an average thickness of at least about 4 and not greater than about 20 nm.

9. The composite film of claim 1, wherein the over-layer comprises an average thickness of at least about 0.015 mm and not greater than about 3 mm.

10. The composite film of claim 1, wherein the over-layer comprises a first surface in contact with the discontinuous silver-based functional layer and wherein the first surface of the over-layer comprises an average surface roughness of at least about at least about 1 micron and not greater than about 200 microns.

11. The composite film of claim 1, wherein the over-layer comprises a second surface not in contact with the discontinuous silver-based functional layer and wherein the second surface of the over-layer comprises an average surface roughness of at least about at least about 1 micron and not greater than about 200 microns.

12. The composite film of claim 1, wherein the composite film comprises an average thickness of at least about 0.03 mm and not greater than about 2 mm.

13. The composite film of claim 1, wherein the composite film comprises an R/sq value or at least about 40 Ohm/sq.

14. A laminate comprising:
a first substrate;
a discontinuous silver-based functional film overlying the first substrate;
an over-layer comprising TPU and overlying the discontinuous silver-based functional film, and
a second substrate overlying the over-layer,
wherein the laminate comprises an R/sq value of at least about 30 Ohm/sq.

15. The laminate of claim 14, wherein the discontinuous silver-based functional film comprises at least one discontinuity over a length of 1 cm of the functional film.

16. The laminate of claim 15, wherein the discontinuities of the discontinuous silver-based functional film have an average gap length of at least about 0.1 microns and not greater than about 100 microns.

17. The laminate of claim 14, wherein the discontinuous silver-based functional film comprises an irregular distribution of discontinuities.

18. The laminate of claim 14, wherein the discontinuous silver-based functional film comprises a regular distribution of discontinuities.

19. The laminate of claim 14, wherein the discontinuous silver-based functional film comprises an average thickness of at least about 5 and not greater than about 500 nm.

20. A method of forming a composite film comprising:
providing a silver-based functional film attached to a first surface of a sacrificial film;
conducting a first lamination of an over-layer onto a second surface of the silver-based functional film, wherein the over-layer comprises TPU, and wherein the silver-based functional film is between the over-layer and the sacrificial film; and
conducting a delamination of the silver-based functional film from the sacrificial film to form a discontinuous silver-based functional film attached to the over-layer to form a composite film.
